(19) United States
(12) Patent Application Publication
(10) Pub. No.: US 2025/0200731 A1
(43) Pub. Date: Jun. 19, 2025

(54) IDENTITY VERIFICATION AND DEEPFAKE PREVENTION FOR ELECTRONIC VIDEO COMMUNICATION

(71) Applicant: Adeia Guides Inc., San Jose, CA (US)

(72) Inventors: Ning Xu, Irvine, CA (US); Dhananjay Lal, Englewood, CO (US); Reda Harb, Tampa, FL (US)

(21) Appl. No.: 18/538,909

(22) Filed: Dec. 13, 2023

(51) Int. Cl. G06T 7/00; G02B 27/01; G06V 40/10; G06V 40/12; G06V 40/16; G06V 40/18; G10L 17/00; H04N 7/14

(52) U.S. Cl. CPC G06T 7/0002; G02B 27/017; G06V 40/11; G06V 40/1365; G06V 40/172; G06V 40/176; G06V 40/197; G10L 17/00; H04N 7/141; G02B 2027/0138; G06T 2207/10016; G06T 2207/20081; G06T 2207/20084; G06T 2207/30201

(57) ABSTRACT

Methods and systems are described for identity verification and deepfake prevention. A first video of a person is captured during an in-person interaction, the person's identity is verified, and the video is associated with the verified identity. In a subsequent electronic interaction, information about a second person is accessed, a second video of the second person is captured, and a trained neural network model is used to determine if the second person is attempting to identify as the first person. If the second person is not attempting to identify as the first person, the electronic interaction proceeds. If the second person is attempting to identify as the first person, the model determines if the first person is likely the same as the second person, transmitting a positive indicator if likely the same, and a negative indicator if not. Related networks, models, apparatuses, devices, techniques, and articles are also described.

### FIELD OF THE DISCLOSURE

The present disclosure relates to authentication, authorization, access, image acquisition, image recognition, image processing, communications, collaboration, video and audio communications, and the like.

### SUMMARY

Artificial Intelligence (AI) has made strides in recent years, with applications ranging from person recognition to the creation of deepfakes (i.e., synthetic media including digital content that has been manipulated to convincingly swap one person's appearance with another's). However, these advancements have not come without challenges and limitations. AI technology, particularly deepfakes, has been misused for fraudulent purposes. This misuse has led to increased scrutiny and regulation of AI apps, but the threat to online privacy and security remains.

The rising sophistication of deepfake technology realistically replaces one person's face and voice in a video with another's, thus presenting challenges to identity verification in online video communication. Deepfake technology learns the patterns and features of the source person's face and voice, and then generates similar patterns to be mapped onto the target person's face and voice in the video. The result is a video that appears to show the target person speaking and behaving as the source person would. This creates a convincing illusion that the target person is saying or doing things that they never actually said or did. Deepfakes are implemented in near real time, using one person to drive a video of another person, like a real-human avatar. This technology also poses ethical and security concerns, as it can be used to create fraudulent content or disinformation.

For years, unique physical characteristics such as faces, iris patterns, and voice characteristics have been leveraged in biometric identification. With the advent of augmented reality (AR) technology, 3D biometrics, capturing more detailed physical characteristics, have come into play, offering potential enhancements to identification processes. Simultaneously, the study of individual gesture and facial expressions under the purview of biomechanics has garnered interest for identification purposes. In some approaches, individuals are recognized based on their gait, head and hand movements, eye movement, and the like that may be captured with a virtual reality (VR) system. However, the accuracy of these recognition systems can vary greatly, and they also raise privacy concerns.

Furthermore, the study of micro-expressions (MEs) and the detection of deepfake videos, present their own set of challenges. Analyzing MEs is difficult due to their short duration and low intensity. Some deepfake identification systems require users to upload a video and do not work in real time. While generative adversarial network (GAN) discriminators have been used to detect deepfake videos, they do not perform well on videos from unknown sources.

While AI technology for deepfake and deepfake detection has made impressive advancements, it is not without its limitations and potential for misuse. There is a pressing need for improvement.

These and other limitations of these approaches are overcome with methods and systems provided herein for identity verification and deepfake prevention for electronic video communication.

During an in-person, face-to-face communication, AR glasses worn by one user are used to collect comprehensive information about another user involved in the communication and/or about the wearer of the AR glasses during the communication. In some embodiments, biometrical and biomechanical information is extracted from the comprehensive information. The extracted information is input into a neural network to train and build at least one model (e.g., for interactions between the a first person and a second person, and the like). The model is updated in subsequent communications with the same one user or other users. The model is tested against known deepfake videos.

In some embodiments, prior to an electronic video communication, in a verification mode, real time analysis compares an observed individual's characteristics with stored biometrical and/or biomechanical information and/or with a model trained on the individual. If a match is confirmed, the stored biometrical and/or biomechanical information associated with the model are updated with the new data. However, if the comparison indicates no match, an alert or warning is provided thus enhancing security of the electronic communication.

Systematic processes for identity verification and deepfake prevention are provided. Use of AR glasses for data collection during in-person communication provides for capture of both biometrics and/or biomechanics regarding a person requiring verification, i.e., the appearance and dynamics of the person are captured. Verification mechanisms are implemented including prompting the user wearing the AR glasses to confirm the identity of the person involved in the communication. Real time verification is achieved with at least one of biomechanics of visual cues, biomechanics of audio cues, biometrics cues, combinations of the same, or the like. The combination of biomechanics and biometrics reduces a risk of deepfakes, which may rely on limited biometrics to disguise a user. A deepfake detection model is, in some embodiments, user-specific, meaning different users have different models to detect deepfakes from their contacts. Data is collected from all videos of people interacting with a device of a user, for example. The collected data is used to train a model that is specifically for the user, for example. Some components of the deepfake detection model are audience-dependent, for example.

In some embodiments, interactions between a primary user and a subject user are incorporated into the model. In other words, biometrics and biomechanics of both users are synchronized and analyzed.

In some embodiments, deepfakes are deliberately generated based solely on biometrical data and used to train the model. By training the model with deepfakes based solely on biometrical data, in these embodiments, the resulting model utilizes biomechanics as a discriminator and ignores characteristics that are relatively easily faked.

The model is adaptable in some embodiments. That is, the model is incrementally updated and fine-tuned with newly captured videos. Thus, the model is made more effective against evolving deepfake technologies.

In some embodiments, during an in-person interaction, a video of a person is captured using a first imaging device. The person's identity is verified, and their biometrical and/or biomechanical information is extracted from the video. During a subsequent electronic interaction, a second video of a person is captured. Biometrical and/or biomechanical information is extracted from this video. A trained neural network model is used to determine if the person in the first video is the same as the person in the second video. If the two people are determined to be the same, a positive indicator is transmitted. If they are not the same, a negative indicator is transmitted. In the case of a negative indicator, the first person is alerted, and information about the second video is sent to their device.

The first imaging device is, in some embodiments, a wearable device, such as AR glasses, mixed reality glasses, a light field camera, a volumetric capture device, a depth-sensing camera, or a smartphone.

Additional biometrical and/or biomechanical information are captured from the operator of the first imaging device using another wearable device. This information is then correlated with the information from the first person. The additional wearable device is, in some embodiments, AR glasses, mixed reality glasses, a light field camera, a volumetric capture device, a depth-sensing camera, a smartphone, a smart watch, or a smart ring.

The identity of the first person is verified by prompting the operator of the first imaging device in some embodiments.

In some embodiments, biometrical information and/or the biomechanical information includes data from, for example, behavioral profiling, face recognition, gait, hand geometry, iris recognition, palm veins, retina recognition, ear shape, vocal biometrics (e.g., filling words and the like), or voice recognition. The biomechanical information includes data from, for example, arm movement analysis, eye movement analysis, finger movement analysis, gait analysis, hand movement analysis, head movement analysis, kinematics, markerless motion capture, or posture analysis.

In some embodiments, a model of the neural network is trained to identify the first person. The training of the model is based on, for example, raw video data obtained during a verified interaction with a first person to be subsequently authenticated. In some embodiments, the training of the model is based on the extracted biometrical and/or biomechanical information. The training of the neural network model includes defining the model, compiling it, adjusting its weights, and evaluating it. The defining of the model includes specifying its architecture, the number of layers, the number of neurons in each layer, and activation functions. The compiling includes specifying a loss function, calculating a loss based on the loss function, and adjusting the model's weights based on the calculated loss. The weights are adjusted by minimizing the loss. The model is evaluated by comparing it to a test dataset to ensure its ability to generalize to new, unseen data.

Before training the model, in some embodiments, the extracted biometrical and/or biomechanical information is preprocessed. In some embodiments, hyperparameters and the learning rate of the model are tuned during the compiling. The preprocessing includes, for example, data cleaning, augmentation, and the like.

Multiple trained models are accessed for a positively identified person captured from multiple imaging devices associated with multiple users in some embodiments. For example, an assembling technique is utilized to obtain an optimized model by combining multiple models. The determination of whether the first person is likely to be the same person as the second person is performed with the optimized trained model.

In some embodiments, a verified person's deepfake video is accessed and/or generated. One or more negative samples from the deepfake video are used to train a model of a neural network. The trained model determines if the first person matches a second person in another video, using various evaluation methods.

In some embodiments, a known deepfake video of the first person is accessed, and a model of the neural network is trained with this information. For example, the latest deepfake models are used to generate additional training samples for training and improving the model. The determination of whether the first person is likely to be the same person as the second person includes evaluating the second video with the model. The evaluating of the second video with the model includes, for example, use of performance metrics, a confusion matrix, cross-validation, a learning curve, a similarity metric, or ensemble learning.

In some embodiments, a known deepfake video of the first person is accessed, biometrical and/or biomechanical information is extracted from the video, and a model of the neural network is trained with this information.

The trained model of the neural network used to identify the first person with the extracted biometrical and/or biomechanical information is, in some embodiments, a user-specific and audience-specific trained model.

The present invention is not limited to the combination of the elements as listed herein and may be assembled in any combination of the elements described herein.

These and other capabilities of the disclosed subject matter will be more fully understood after a review of the following figures, detailed description, and claims.

### BRIEF DESCRIPTIONS OF THE DRAWINGS

The present disclosure, in accordance with one or more various embodiments, is described in detail with reference to the following figures. The drawings are provided for purposes of illustration only and merely depict non-limiting examples and embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein may be better understood by referring to the following description in conjunction with the accompanying drawings, in which like reference numerals indicate identical or functionally similar elements, and in which:

FIG. 1A depicts identity verification and deepfake prevention for electronic video communication, in accordance with some embodiments of the disclosure;

FIG. 1B depicts identity verification and deepfake prevention for electronic video communication utilizing biometric and/or biomechanical information, in accordance with some embodiments of the disclosure;

FIG. 2 depicts a plurality of user-specific models trained from videos captured from contacts interacting with a user (e.g., in-person interactions), in accordance with some embodiments of the disclosure;

FIG. 3 depicts a system for deepfake detection, in accordance with some embodiments of the disclosure;

FIG. 4 depicts a system using a deepfake process to augment a training dataset, in accordance with some embodiments of the disclosure;

FIG. 5 depicts time series data on interactions between pairs of humans used to train a learning model, in accordance with some embodiments of the disclosure;

FIG. 6A depicts a process for a learning and/or training phase of identity verification and deepfake prevention for electronic video communication, in accordance with some embodiments of the disclosure;

FIG. 6B depicts a process for an inference phase of identity verification and deepfake prevention for electronic video communication, in accordance with some embodiments of the disclosure;

FIG. 7 depicts a process for identity verification and deepfake prevention for electronic video communication (e.g., including display and alert functions), in accordance with some embodiments of the disclosure;

FIG. 8 depicts a process for identity verification and deepfake prevention for electronic video communication (e.g., including training functions), in accordance with some embodiments of the disclosure;

FIG. 9 depicts a process for identity verification and deepfake prevention for electronic video communication (e.g., including training functions), in accordance with some embodiments of the disclosure;

FIG. 10 depicts a process for identity verification and deepfake prevention for electronic video communication (e.g., including model adjustment functions), in accordance with some embodiments of the disclosure;

FIG. 11 depicts a process for identity verification and deepfake prevention for electronic video communication (e.g., including model tuning functions), in accordance with some embodiments of the disclosure;

FIG. 12 depicts a process for identity verification and deepfake prevention for electronic video communication (e.g., including a plurality of trained models), in accordance with some embodiments of the disclosure;

FIG. 13 depicts a process for identity verification and deepfake prevention for electronic video communication (e.g., including training functions), in accordance with some embodiments of the disclosure;

FIG. 14 depicts a process for identity verification and deepfake prevention for electronic video communication (e.g., including training functions), in accordance with some embodiments of the disclosure;

FIG. 15 depicts an artificial intelligence system, in accordance with some embodiments of the disclosure; and

FIG. 16 depicts a system including a server, a communication network, and a computing device for performing the methods and processes noted herein, in accordance with some embodiments of the disclosure.

The drawings are intended to depict only typical aspects of the subject matter disclosed herein, and therefore should not be considered as limiting the scope of the disclosure. Those skilled in the art will understand that the structures, systems, devices, and methods specifically described herein and illustrated in the accompanying drawings are non-limiting embodiments and that the scope of the present invention is defined solely by the claims.

### DETAILED DESCRIPTION

AR glasses and video communication systems are configured to identify individuals based on unique physical and vocal characteristics. AR glasses are provided to record real-world interactions and accurately measure various biometric and biomechanical parameters. In some cases, they can also track hand and finger movements. Other devices with motion sensors, like smartphones, smart watches, other dedicated controllers (e.g., for operation with the AR glasses), or the like, for example, can be used alongside the AR glasses to enhance the user verification process.

For example, AR glasses and video communication systems are integrated with advanced 3D biometric, visual biomechanical, and voice biometric analysis techniques to create and continually update a unique identity signature for an individual. In some embodiments, such signature is made accessible to one or more applications (e.g., a video conferencing application) for verification. In some embodiments, a user of a device authorizes an app to utilize one or more signatures associated with the user for verification purposes. AR glasses are uniquely positioned to capture offline videos from the real and known person in real conversations offline, in the physical world. AR glasses are configured to precisely measure biometric (e.g., iris detection and voice fingerprint) and/or biomechanic (head movement) parameters. In some embodiments, AR glasses also measure hand and finger movement, through image and time of flight sensors. In some embodiments, any suitable device that captures data of one or more unique user signatures is utilized. For example, AR glasses measure eye movement using an inwardly facing eye camera (e.g., an infrared (IR) camera). In this manner AR glasses capture an additional biomechanic for user verification. Other devices that have inertial measurement sensors to measure head and hand movement are, in some embodiments, used in conjunction with the AR glasses. The other devices include, for example, a smartphone, smart watch, smart ring, or the like. For example, in some embodiments, AR glasses are worn by both persons, the AR glasses on a primary user capture video and voice of the subject user, and the AR glasses on a subject user capture the voice, inertial measurement unit (IMU) data, and the like about the subject user. The subject user can also wear other devices such as a smart watch, a smart ring, and the like, which provide some additional data about the subject user.

In some embodiments, in offline, face-to-face interactions, the AR glasses capture and analyze a comprehensive range of data points. These include 3D physical characteristics, facial expressions, gestures, voice characteristics, and unique biomechanical signatures. Given that offline interactions involve a verified real person, the system uses this trusted data to build and update the individual's identity signature.

Holographic video conferencing technology is leveraged. For example, in many holographic video conferencing systems, a set of cameras (vision and/or depth) are used to create in real time, a 3D representation of a user. This 3D representation is, for example, in the form of a volumetric capture (e.g., meshes), lightfield (e.g., plenoptic function), or another format. In some embodiments, when a user does not have AR glasses or other biometric and/or biomechanic sensors on their person, then a capture system is provided as input into a machine learning (ML) model (explained herein). The capture system is also used in addition to the other sensors in some embodiments. Further, generative AI models are leveraged. For example generative AI models are utilized to convert 2D video into 3D object representations. If, for example, the only input available to a system is 2D video, then, in some embodiments, the system applies an intermediate step of using a pre-trained AI model (e.g., trained on human head and hand movement videos) to generate 3D representations of the user's movement, which are used to extract biomechanics.

Prior to or during electronic video communications, where authenticity of an individual on another end of the communication is not guaranteed, in some embodiments, the system first operates in a verification mode. The system performs real time analysis comparing characteristics of an individual (e.g., collected with one or more devices) with stored 3D biometric, biomechanical, and voice biometric signatures. If, in some embodiments, a match is confirmed, then the system continues to update the signature with the new data. However, if the comparison raises suspicions or does not match, then the system provides a warning thus enhancing the security of the electronic interaction. Also, in some embodiments, the verification mode occurs before the participant is admitted to a video conference. For example, the verification process is triggered in response to the participant initiating joining a video conference (e.g., clicking on a link). If verification fails, then the participant may be restricted from joining the conference.

Methods and systems are provided for capturing a video of a person during an in-person interaction using a first imaging device, verifying the person's identity, and associating the video with the verified identity. In some embodiments, during a subsequent electronic interaction, information about a second person is accessed, a second video of the second person is captured, and a trained neural network model is used to determine if the second person is attempting to identify as the first person. The determination of whether the second person is attempting to identify as the first person includes, in some embodiments, analysis of one or more of types of audio, video, and/or electronic interactions associated with identity. For example, during a social broadcast (e.g., Facebook Live), it is determined that the second person is attempting to identify as the first person when at least one of the following conditions occurs: the second person introduces themselves as “Person A,” when other participants in the video conference refer to the second person as “Person A,” when the second person identified themselves as Person A when entering a “display name, combinations of the same, or the like.

If the second person is not attempting to identify as the first person, the electronic interaction proceeds. If the second person is attempting to identify as the first person, the model determines if the first person is likely the same as the second person and transmits a positive or negative indicator accordingly.

The method also includes, for example, displaying the indicator, alerting the first person by transmitting a deepfake indicator to their device, and transmitting information about the second video to the first person's device. The first imaging device can be a wearable device such as augmented reality glasses, mixed reality glasses, a light field camera, a volumetric capture device, a depth-sensing camera, or a smartphone.

In some embodiments, the methods and systems involve extracting biometrical and/or biomechanical information from a first video of a person, training a neural network model with this extracted information, and capturing additional biometrical and/or biomechanical information from an operator using an additional wearable device. For example, timestamps of the extracted information are correlated with those of the additional information, and the trained model includes analysis of the correlated additional information. The identity of the first person is verified by prompting an operator. In some embodiments, some devices (e.g., iPhones) are configured with on-device ML models that classify pictures with initial input from users (e.g., this is User X, this is User Y, and the like). In some embodiments, a device is configured to identify a user within a field of view of the device. For example, the device may be configured to identify a user within a field of view of the device based on one or more pictures and videos of the user.

The biometrical and/or biomechanical information includes, for example, data based on behavioral profiling, face recognition, gait, hand geometry, iris recognition, palm veins, retina recognition, ear shape, vocal biometrics, voice recognition, arm movement analysis, eye movement analysis, finger movement analysis, gait analysis, hand movement analysis, head movement analysis, kinematics, markerless motion capture, or posture analysis. The training of the model includes defining, compiling, adjusting the weights of, and evaluating the model.

In some embodiments, the methods and systems involve defining the architecture of a neural network, including the number of layers, neurons, and activation functions. The model is compiled by specifying a loss function, calculating the loss, and adjusting the weights based on the calculated loss. The weights are adjusted to minimize the loss. The model is evaluated by comparing it to a test dataset to ensure its ability to generalize to new data.

Before training, information is preprocessed, in some embodiments. The model is trained based on the preprocessed information. In some embodiments, hyperparameters and the learning rate are tuned.

The method also involves accessing multiple trained models, comparing them, and training an optimized model based on the comparison, in some embodiments. The determination of whether the first person is likely the same as the second person is performed with the optimized model.

The method also involves accessing and/or generating a known deepfake video of a first person, where the first person is already verified, in some embodiments. The known deepfake video is different from the generated deepfake video. Deliberately creating deepfake videos and training the model with such helps to balance the training data set and reduce bias of the model. At least one negative sample from the known deepfake video is accessed. In some embodiments, many negative samples from the known deepfake video are accessed and utilized. The neural network model is trained based on the at least one negative sample and the known deepfake video. Using the trained model, a determination is made as to whether the first person is likely to be the same as a second person. A second video is evaluated with the model. The evaluation includes at least one of performance metrics, a confusion matrix, cross-validation, a learning curve, a similarity metric, ensemble learning, combinations of the same, or the like.

The method also includes in some embodiments accessing a known deepfake video, extracting negative samples, and training the model based on these samples. The second video is evaluated with the deepfake model, which includes, for example, use of performance metrics, a confusion matrix, cross-validation, a learning curve, a similarity metric, or ensemble learning, for example.

In some embodiments, the methods and systems involve extracting biometrical and/or biomechanical information from a first video of a person. This extracted information is then used to train a neural network model to identify the first person from a second video of a second person. The trained model is user-specific and audience-specific in some examples, meaning it is tailored to identify the first person based on the extracted information.

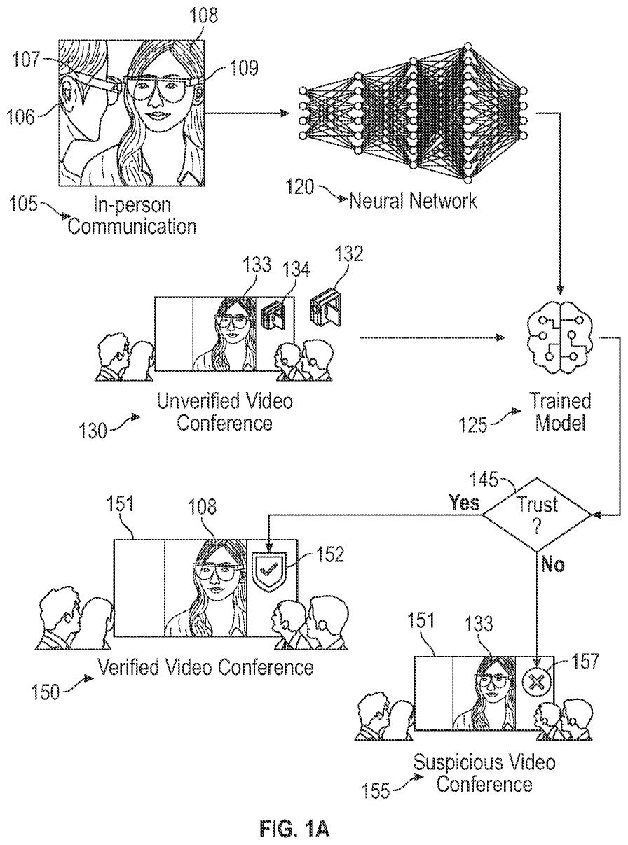

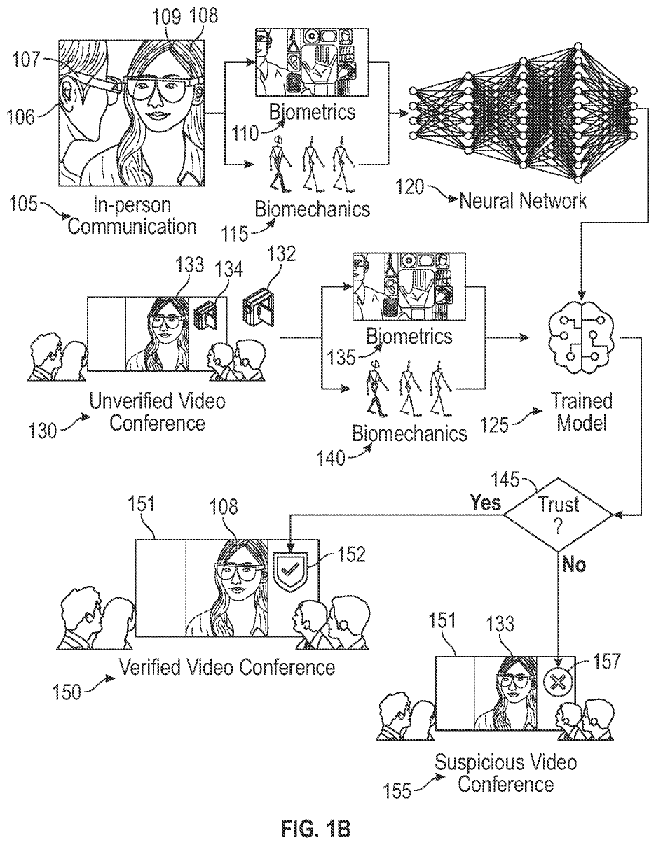

FIG. 1A depicts identity verification and deepfake prevention for electronic video communication, in accordance with some embodiments of the disclosure. As shown in FIG. 1A, for example, a first person 106 is conducting an in-person communication 105 with a second person 108. In some embodiments, the first person 106 and/or the second person 108 is wearing AR glasses. As shown in FIG. 1A, each of the first person 106 and the second person 108 is wearing AR glasses 107, 109, respectively. Other types of devices (e.g., other types of imaging devices, various types of sensors, combinations of the same, or the like) are suitable in some embodiments.

Video from the AR glasses 107 and/or the AR glasses 109 is sent to a neural network 120 (various embodiments of the neural network 120 are described in detail herein). The neural network 120 results (e.g., through various processes detailed herein) in a trained model 125.

At a subsequent time, for example, a second person 133 presents themselves as the first person 108. The second person 133 is conducting an as of yet unverified video conference 130 with a person or group of persons. In some scenarios, as shown in FIG. 1A, the second person 133 is wearing AR glasses, and a camera 132 is trained on the group participating in the unverified video conference 130. Also, in some scenarios, a camera 134 is trained on the second person 133 participating in the unverified video conference 130.

For example, video from the AR glasses 109 and/or the camera 134 is sent to the trained model 125. A trust determination 145 (various embodiments of the trust determination 145 are detailed herein) is performed. If the trained model 125 determines a relatively high likelihood (e.g., at or above a predetermined threshold or using any other suitable metric) that the person 133 is, in fact, the same person as the person 108 (145=“Yes”), then the unverified video conference 130 is instead associated with and/or referred to as a verified video conference 150. In some embodiments, when it is determined that the unverified video conference 130 is the verified video conference 150, a display device 151 is configured to display an indicator, such as a positive indicator 152 (e.g., a green check mark on a shield logo).

If, however, for example, the trained model 125 determines a relatively low likelihood (e.g., below a predetermined threshold or using any other suitable metric) that the person 133 is likely to be the same person as the person 108 (145=“No”), then the unverified video conference 130 is instead associated with and/or referred to as a suspicious video conference 155. In some embodiments, when it is determined that the unverified video conference 130 is the suspicious video conference 155, the display device 151 is instead configured to display an indicator, such as a negative indicator 157 (e.g., a red X mark in a circle).

The trust determination 145 includes, for example, one or more of the determinations 645, 705 described in detail herein. In some embodiments, the trust determination 145 includes, again for example, at least one of the trained models 125, 253, 256, 259, 1720, 1725 of a neural network trained to identify the first person 108 described in detail herein.

FIG. 1B depicts identity verification and deepfake prevention for electronic video communication utilizing biometric and/or biomechanical information, in accordance with some embodiments of the disclosure. Descriptions of references in FIG. 1B that are the same as references in FIG. 1A are omitted for brevity.

In some embodiments, as shown in FIG. 1B, for example, preprocessing of the video occurs before processing by the neural network 120 and/or before assessment by the trained model 125. For example, biometrics 110 and/or biomechanics 115 are extracted from the video of the in-person communication 105. Also, for example, biometrics 135 and/or biomechanics 140 are extracted from the video of the unverified video conference 130. Examples of biometrics 110, 135 and/or biomechanics 115, 140 are detailed herein.

In some embodiments, the proposed system and methods are user specific. For example, the user is defined as someone who benefits from using the software and/or applications. Therefore, assistance is provided to the user to help the user know whether the video of a person video-chatting with them is likely to be deepfaked or not. For example, user specific ML based deepfake detection models are trained based on videos of persons who interacted with the user. Biomechanics includes, for example, temporal face expressions, and other responses that are audience dependent, so the user specific ML based deepfake detection models are, in some embodiments, specific to the participants (e.g., audience-specific) in the communication.

In some embodiments, for each user, a user-specific model is trained. In other embodiments, the user-specific training data is used to fine-tune a large deepfake detection model to improve the performance for specific user to detect whether the one video-chatting with them is deepfaked.

Advanced AR glasses are provided, in some embodiments, with one or more sensors for detecting human expressions. Expressions may be voluntary, and a result of human training, or involuntary. MEs are rapid, involuntary facial expressions, which reveal emotions that people do not intend to show. MEs last for shorter durations, about 0.5 seconds or less. In some embodiments, a human's expressions and MEs in response to other individuals' stimuli provide identification signatures. Using videos and/or sensors on AR glasses, a user's expressions or MEs in response to stimuli from other specific participants are detected and recognized. In some embodiments, these are also used in training ML models for detecting whether a user's expression or ME signatures are consistent with past videoconferences featuring the same individuals, thus helping to isolate deepfakes.

As discussed in detail herein, comprehensive solutions are provided for identity verification. The solutions provide a line of defense against deepfake-induced identity fraud in the ever-evolving landscape of electronic video communication. The solutions also ensure a seamless user experience by incorporating, for example, AR glasses, which are increasingly popular.

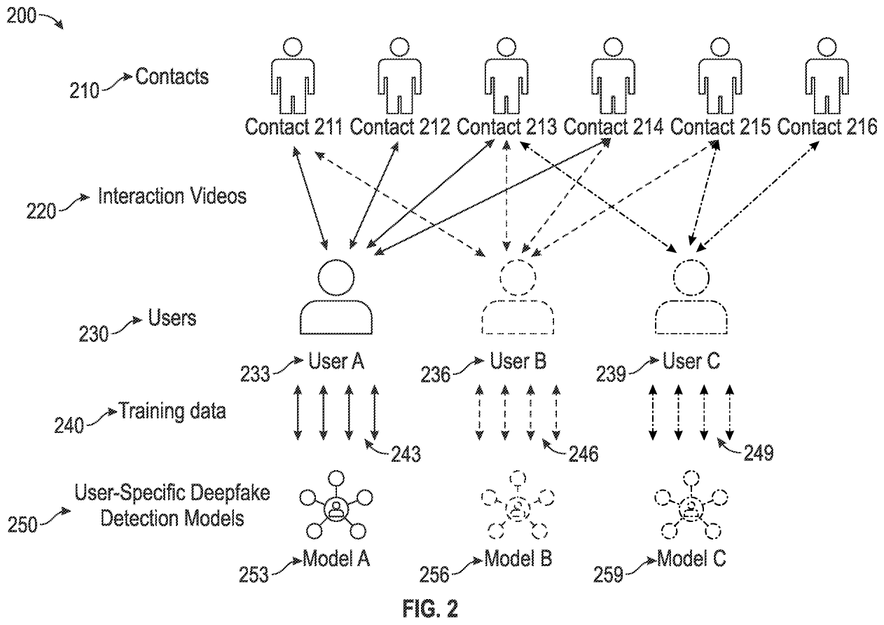

Systematic methods of identity verification are provided against deepfake in video communication. In some embodiments, a system involves the use of AR glasses to collect data that capture both the appearance and dynamics of a person, ensuring that the data is from a real person and not a deepfake video. It allows for real-time verification using both visual and audio cues, focusing more on the dynamic aspects of appearance rather than the static aspects of appearance, which are often manipulated in deepfakes. The deepfake detection model is tailored to each user, with different models for different users (as shown and described herein with reference to, for example, FIG. 2). This is achieved by collecting training data from all videos of people interacting with a user and training a model specifically for that user. The system also cleverly uses existing deepfake technology to generate deepfaked videos with preserved identity labels, creating a comprehensive dataset for training the identity verification model. The system is designed to be adaptable and can be updated or fine-tuned with newly captured videos, making it effective against evolving deepfake technologies.

In some embodiments, training a model includes at least one of the following: training a model of a neural network to identify a person with extracted biometrical information and/or extracted biomechanical information from a video of the person; defining a model of a neural network; compiling a model of a neural network; adjusting weights of a model of a neural network; evaluating a model of a neural network; defining an architecture of a neural network; defining a number of layers, a number of neurons in each layer, and activation functions; specifying a loss function used to evaluate a performance of a model of a neural network; calculating a loss based on a loss function; adjusting weights of a model of a neural network based on calculated loss; minimizing a loss; comparing a model of a neural network to a test dataset to ensure an ability of the model of the neural network to generalize to new, unseen data; before training a model of a neural network, preprocessing extracted biometrical information and/or the extracted biomechanical information; training a model of a neural network to identify a person based on preprocessed, extracted biometrical information and/or the preprocessed, extracted biomechanical information; tuning hyperparameters; tuning a learning rate of a model of a neural network during compiling; training a model of a neural network to identify a person based on preprocessed, extracted, and tuned biometrical information and/or the preprocessed, extracted, and tuned biomechanical information; training an optimized trained model for a positively identified person based on a compared plurality of trained models for the positively identified person; training a model of a neural network based on at least one negative sample from a known deepfake video; training a model of a neural network to identify a person with extracted biometrical information and/or the extracted biomechanical information from a second video of the person; training a model of a neural network to identify a person with a user-specific model; training a model of a neural network to identify a person with an audience-specific trained model; combinations of the same; or the like.

In some embodiments, a process of training a model involves receiving a video of a person. That is, in some embodiments, it is not always necessary to first extract biometrical and/or biomechanical information from the video of the person. Rather, all types of information, including biometrical and/or biomechanical information, are captured and/or embedded in hidden layers of the model and weights are adjusted during the training process.

In some embodiments, for example, a process of training a model involves receiving extracted biometrical and/or biomechanical information from a video of a person. This information is preprocessed before training a neural network model. The model is defined, compiled, and its weights are adjusted. The architecture of the neural network, including the number of layers, neurons in each layer, and activation functions, is defined. A loss function is specified to evaluate the model's performance, and the loss is calculated based on this function. The weights of the model are adjusted based on the calculated loss to minimize it. The model is then compared to a test dataset to ensure its ability to generalize to new, unseen data. Hyperparameters and the learning rate of the model are tuned during compiling. The model is trained to identify a person based on the preprocessed, extracted, and tuned biometrical and/or biomechanical information. An optimized trained model for a positively identified person is trained based on a compared plurality of trained models for the positively identified person.

In some embodiments, the model is trained based on samples. For example, the model is trained on video samples where a person is not positively identified. Such video samples include, for example, one or more known deepfake videos, and/or one or more deepfake videos created for this person using other persons (e.g., a static appearance of other persons). To ensure that the training dataset is balanced, in some embodiments, a sufficient number of samples of both positive and negative identification are provided for the training. The model can be trained to identify a person with a user-specific model trained model and/or with an audience-specific trained model.

For example, a system is provided including at least one, some, or all of the following features. AR glasses are utilized for data collection. AR glasses capture both the appearance (biometrics) and the dynamics (biomechanics) of the person. The user wearing the AR glasses is, in some embodiments, prompted during offline and/or in-person interactions to confirm whether a given communication is from a real person instead of a deepfake video. In some embodiments, the system allows real time verification with the biomechanics of both visual and audio cues, while minimizing the effect of biometrics, which is what the deepfake process uses to disguise the user. The deepfake detection model is user-specific, meaning different users will have different models to detect deepfake from their contacts. The system collects training data from all the videos of people interacting with a user and trains a model that is specifically for the user. Some components of the biomechanics are audience-dependent, so user-specific methods are provided in some embodiments to improve performance. In some embodiments, existing deepfake technology is utilized as an advantage. For example, by generating deepfaked videos with preserved identity labels, a comprehensive dataset is created that serves as a foundation for training an identity verification deep learning model focused on biomechanics. The system also allows for incremental updating and/or fine-tuning of the model with newly captured videos. The system is adaptable and effective against evolving deepfake technologies.

FIG. 2 depicts a schematic diagram 200 in which a plurality of user-specific models, for example, model A 253, model B 256, model C 259, and so on, are trained from videos captured from contacts 210, for example, contact 211, contact 212, contact 213, contact 214, contact 215, contact 216, and so on, interacting in various ways with one or more users 230 (e.g., in-person interactions), for example, user A 233, user B 236, user C 239, and so on, in accordance with some embodiments of the disclosure. Various interaction videos 220 are generated, stored and/or recorded. For example, as shown in FIG. 2, each double-headed arrow represents a video of an in-person interaction between two or more parties. For example, an in-person interaction between user A 233 and contact 211 results in an interaction video. In some scenarios, of course, where multiple contacts are present, the video involves all the participants. In some examples, videos with multiple people are parsed into multiple interactions, each one between two specific individuals, e.g., an interaction involving a direct request from one individual to another and the associated response. Eleven (11) interaction videos are depicted in FIG. 2. Of course, the number of interactions depicted in FIG. 2 is merely exemplary.

The interactions of the users 230 with the contacts 210 resulting in interaction videos 220 form a basis for training data 240 for each of the users 230 in some embodiments. For example, for user A 233, four interaction videos of in-person interactions with each of contact 211, 212, 213, and 214 result in training data 243. Training data 240 result from the in-person interactions of user A 233, user B 236, and user C 239 with the various contacts 210 shown in FIG. 2, for example. Eleven (11) sets of training data 240 are depicted in FIG. 2. Of course, the number of sets of training data depicted in FIG. 2 is merely exemplary.

In some embodiments, the training data 240 form a basis for user-specific deepfake detection models 250. For example, as shown in FIG. 2, the training data 243 for in-person interactions involving user A 233 forms the basis of a user-specific deepfake detection model 253, the training data 246 for in-person interactions involving user B 236 forms the basis of a user-specific deepfake detection model 256, and the training data 249 for in-person interactions involving user C 239 forms the basis of a user-specific deepfake detection model 259. Since each of the user-specific deepfake detection models 250 involve common contacts 210, comparisons, correlations, inferences, and the like are, in some embodiments, gleaned from the data. The comparisons, correlations, inferences, and the like are, in some embodiments, utilized to tune the user-specific deepfake detection models 250. For example, when user-specific and/or audience-specific models exist, a plurality of models that are applicable to a given scenario are utilized to verify that an entering user is validated. The results of the models are combined based on combinatorial logic and/or using a weighted average, where the weights are based on the confidence of each model in its result (e.g., legitimate user or deepfake).

In some embodiments, offline conversations are captured by different sensors, for example. In some embodiments, AR glasses are used to capture video data during offline conversations. The data captured includes both audio and visual data, each of which contains both biometrics and biomechanics. The biometrics include visual and audio information that deepfake processes use to impersonate other people, including, for example, at least one of the face, mouth, ear, eye, hair, combinations of the same, or the like, of visual appearance and/or at least one of the tone, pitch, volume, combinations of the same, or the like, of speech. The biomechanics include the dynamic aspect of a person's audio and visual information. For example, motion, hand movement, MEs, and the like are detected from visual information. Also for example, filler words, pace, rhythm, articulation, and the like are detected from audio information.

In addition, in some embodiments, both captured biometrics and biomechanics data include at least one of user-specific portions, audience-specific portions, combinations of the same, or the like. Inferencing may be performed when multiple types of data are available, i.e., user-specific and audience-specific, as discussed in detail herein. For example, a given person may respond to different people with different gestures, MEs, tones, or paces. While deepfake processes usually only capture a general aspect of visual and/or audio appearance, a specific portion of the data is utilized against deepfake processes in some embodiments.

In some embodiments, during the offline face-to-face interactions, individuals are equipped with AR glasses that are designed with built-in cameras, sensors, and microphones. AR glasses record visual and/or audio cues throughout an interaction. To enable automatic association of captured videos with a correct identity, robust face recognition techniques are employed in some embodiments. The robust face recognition techniques automatically detect and identify the faces of individuals captured by the AR glasses during the offline interactions. In some embodiments, by implementing a reliable face recognition process, the detected faces are matched against a database of known individuals, and/or new identities are created for unrecognized faces.

The captured videos, along with their corresponding identity labels and timestamps, are stored securely and organized in a structured manner in some embodiments. A database and/or file system is implemented to facilitate easy retrieval and indexing of the videos based on the associated identities. In some embodiments, AR glasses are utilized to create biometric and/or biomechanic time series data of the user in offline scenarios. For example, when the user wearing glasses authenticated themselves, the authentication creates a label for the model. The data obtained, for example, from the IMU in the head mounted display (HMD), which includes one or more sensors (e.g., pose, velocity, acceleration, and the like), is used to recreate head movement data. In some embodiments, data from an inward facing IR camera is used to generate eye movement data. Similarly, for example, data (such as IMU data) is transmitted from controllers, trackers, body suits, and/or other devices to the HMD. Such data is sent to a module responsible for training. The training module utilizes this data for model training, since the biomechanic peculiarities of head and/or hand movement, limb movement, and the like, of an individual are contained in the data. In some embodiments, a device equipped with an inward facing camera is configured to capture and/or identify an emotion, and/or sentiment, and/or expression of the wearer.

In some embodiments, videos are associated with correct identities. Deepfake technology is employed to generate synthetic videos for each individual. Deepfake techniques are applied to use the visual and/or audio metrics of each individual to generate deepfaked versions of other individuals' videos, while preserving correct identity labels.

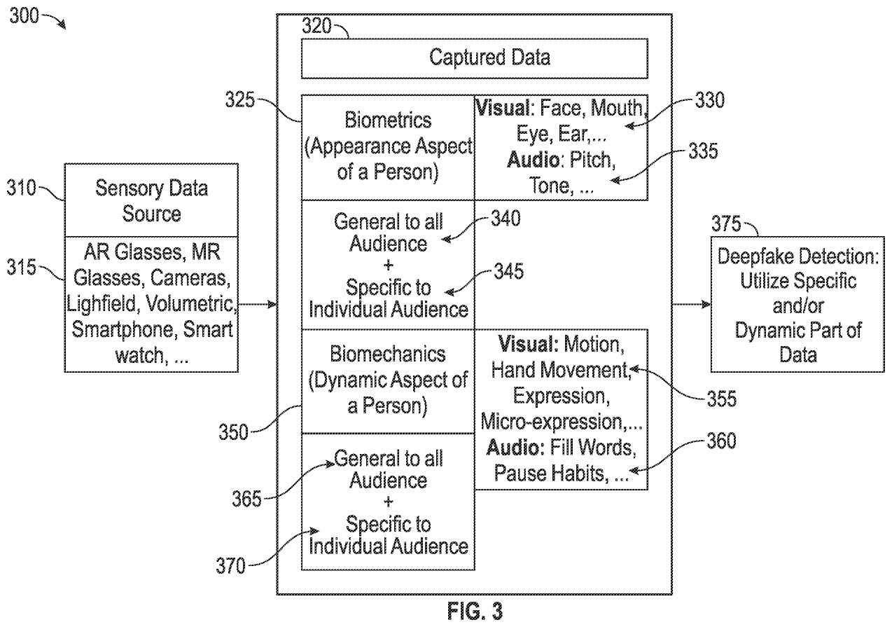

A process of deepfake detection is provided, in accordance with some embodiments of the disclosure. FIG. 3 illustrates an example of a system 300 of identity verification against deepfake, according to some embodiments. The system 300 includes at least one of sensory data sources 310, captured data 320 from the data sources 310, and a deepfake detection module 375 based on the captured data 320 from the data sources 310, combinations of the same, or the like. For example, the sensory data sources 310 include at least one of a plurality of devices 315 including AR glasses, smart glasses, mixed reality (MR) glasses, VR headsets, cameras (e.g., 360-degree cameras), lightfield sensors, volumetric sensors, smartphones, smart watches, haptic feedback devices, smart home devices, wearable fitness trackers, portable game consoles, tablets, lidar sensors, combinations of the same, or the like.

For example, the captured data 320 includes, in some embodiments, biometrics (e.g., an appearance aspect of a person) 325 and biomechanics 350 (e.g., a dynamic aspect of a person).

For example, the biometrics 325 includes, in some embodiments, visual attributes 330 and audio attributes 335. The visual attributes 330 include at least one of face, mouth, eye, ear, nose, hair, skin, eyebrow, cheek, chin, forehead, neck, teeth, lip, combinations of the same, or the like. The audio attributes 335 include at least one of pitch, tone, rhythm, timbre, inflection, prosody, volume, duration, harmony, melody, tempo, dynamics, texture, form, articulation, beat, combinations of the same, or the like. The biometrics 325 are, in some embodiments, general to all audiences 340 and/or specific to individual audiences 345.

For example, the biomechanics 350 includes, in some embodiments, visual attributes 355 and audio attributes 360. The visual attributes 355 include at least one of motion, hand, movement, expression, micro-expression, posture, gait, gestures, eye movement, muscle tension, body orientation, proximity, touch, breathing rate, blink rate, combinations of the same, or the like. The audio attributes 360 include at least one of fill words, pause habits, speech rate, volume, pitch, intonation, articulation, voice quality, stress patterns, laughter, non-verbal sounds, accent, dialect, speech disfluencies (e.g., stutter and self-correction), combinations of the same, or the like. The biomechanics 350 are, in some embodiments, general to all audiences 365 and/or specific to individual audiences 370.

In some embodiments, the deepfake detection module 375 utilizes specific and/or dynamic parts of the captured data 320. In some embodiments, the deepfake detection module 375 includes an AI model and/or a neural network. In some embodiments, the deepfake detection module 375 utilizes at least one of user-specific data, audience-specific data, separated user-specific data from a communication having more than two participants, combinations of the same, or the like.

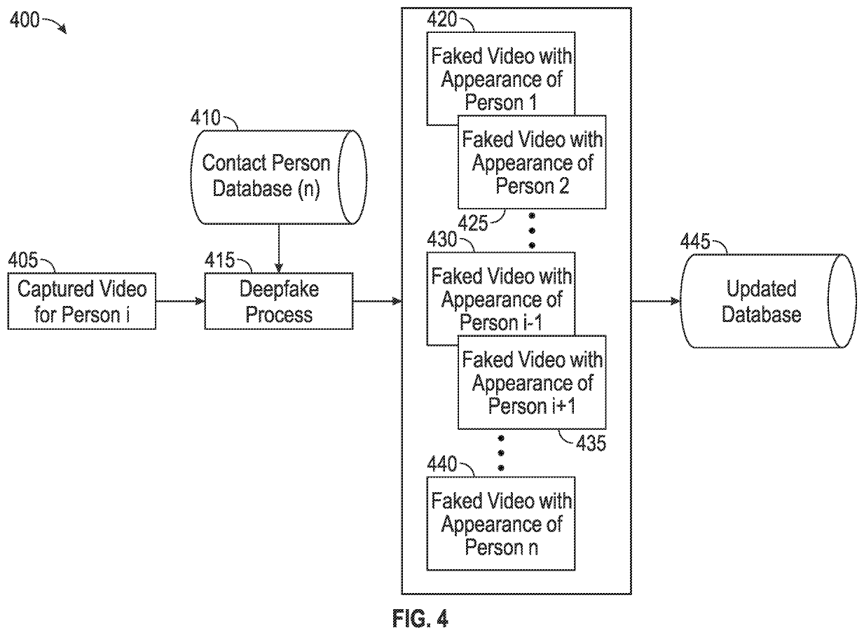

FIG. 4 depicts a system 400 using a deepfake process to augment a training dataset, in accordance with some embodiments of the disclosure, i.e., an exemplary embodiment of data augmentation. In FIG. 4, for example, for each user, there is a dataset of n people. When the user is interacting with the person i offline, a video is captured, and the captured video is added to the database with label i. In some embodiments, at the same time, the captured video is used to generate a deepfake video to impersonate other people in the dataset, obtaining n−1 additional videos with the other person's appearance. All the augmented videos retain the label i. Thus, the resulting dataset forces an ML model to focus on biomechanics, and to detect a deepfake process. As shown, for example, in FIG. 4, the system 400 includes at least one of a captured video for person i 405, a contact person database n 410, a deepfake process 415 (described in greater detail herein), a series of faked videos (described in greater detail herein), an updated database 445, combinations of the same, or the like. The series of faked videos include at least one of a faked video with an appearance of person 1 420, a faked video with an appearance of person 2 425, a faked video with an appearance of person i−1 430, a faked video with an appearance of person i+1 435, a faked video with an appearance of person n 440, combinations of the same, or the like.

In some embodiments, a detailed dataset with real (i.e., authenticated and/or verified, e.g., by in-person interactions) and fake videos (e.g., known and/or generated deepfakes), each of which has a correct label, serves as a foundation for training and evaluating an identity verification deep learning model. The identity verification deep learning model is configured to effectively detect and counter deepfake attempts during electronic video communication.

In recognition of the ongoing evolution of deepfake technology, the dataset is regularly updated with new versions of deepfaked videos. In some embodiments, older versions of deepfaked videos are gradually phased out, augmented, and/or minimized in importance over time. As such, the system remains updated against the latest deepfake methodologies.

In some embodiments, the dataset includes a diverse range of individuals, capturing variations in facial expressions, gestures, speech patterns, and the like. Each video is associated with a correct identity label based on results of a facial recognition process conducted during data collection. The dataset is then, for example, split into training, validation, and testing sets while preserving the correct identity associations.

In some embodiments, an identity verification model is built from scratch. To build an identity verification model from scratch with a diverse dataset of videos involving multiple individuals, in some embodiments, a starting point includes, for example, building a model from a single video of an individual, by providing a common pre-collected dataset of multiple individuals. With a deepfake augmented dataset, the dataset is first split into training, validation, and testing sets while maintaining a balanced distribution of samples for each individual.

In some embodiments, a video transformer, such as a vision transformer (ViT), is used as an underlying architecture to obtain the visual features. The video frames are preprocessed, for example, by resizing them to a consistent resolution and normalizing pixel values to a common scale. Relevant facial landmarks or features are extracted using techniques like face detection and landmark detection. The video data is augmented with techniques such as random cropping, rotation, or flipping to introduce variability and improve the model's generalization.

Audio transformers are used for extracting audio features in some embodiments. For example, the spectrograms of audio signals are first obtained from a video. The spectrograms are provided to a transformer to capture relevant information about speech patterns and voice characteristics.

In some embodiments, the visual features from the visual transformer and the audio features from the audio transformer are combined with a concatenation layer to merge the features into a unified representation. Additional fully connected layers with attention mechanisms are added to the model.

In some embodiments, a model is updated with new captured videos. For example, a model is updated with new time series data. For example, the new time series data includes data representing an individual, such as a captured video and/or captured data from one or more sensors representing biometric and/or biomechanic attributes, are provided when training the model. For example, to keep an identity verification model updated, a system constantly integrates newly captured videos of individuals recorded using AR glasses and/or from other sources. The new videos undergo the same preprocessing stages as in the initial data collection phase, ensuring consistency across the dataset. The new videos are seamlessly integrated with the existing dataset with careful attention to preserving the correct identity associations.

When the system registers a small number of new videos and/or time series data, in some embodiments, an efficient approach of fine-tuning an existing model is applied. The model adapts to new videos without relatively great computation resources. Relatively rapid deployment of the updated model is provided. In the fine-tuning process, for example, trained weights in transformers of a deep learning model are retained, and only the last few layers are trained after the concatenation of visual and audio features with the new data.

In cases where a dataset has expanded substantially, the model is retrained from scratch, in some embodiments. This approach allows the model to fully benefit from a larger pool of data and increases diversity. In some embodiments, old data may be discarded and/or have a lower weight in the training. For example, the old data can be designed to be used to adjust the weights less frequently compared to the other data.

Once a model is updated, in some embodiments, performance is evaluated to ensure effectiveness of the model with the new data. For example, evaluation is performed using a separate validation set and involves assessing metrics such as accuracy, precision, recall, and an F1 score. These evaluations allow for the verification of the model's ability to accurately identify individuals within an expanded dataset. The system's integrity is maintained providing confidence in ongoing effectiveness against evolving deepfake technologies.

Expressions and MEs are utilized in some embodiments. There is a tendency for humans to train themselves to respond to other individuals in a consistent manner. These behaviors manifest in trained expressions and involuntary MEs. In some embodiments, an operating parameter is built on an assumption of consistency in these behaviors when measured as an interaction between a pair of humans or as a group. For example, time series data on interactions between pairs of humans is used to train a learning model.

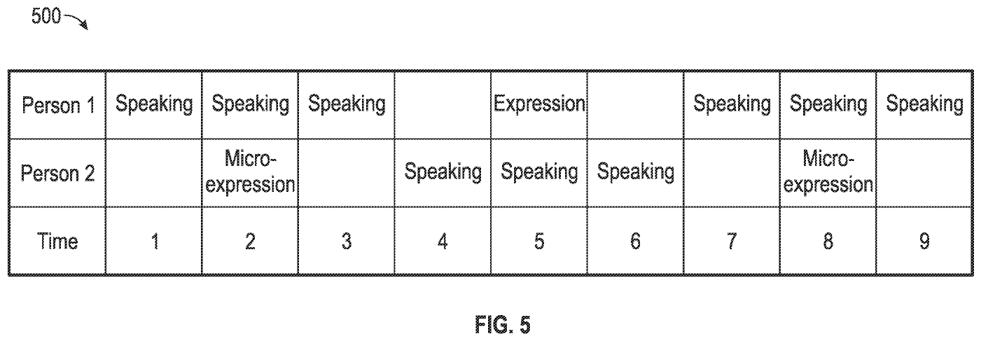

FIG. 5 illustrates, for example, how a ML model is trained on time series data. FIG. 5 illustrates, for example, a first person (i.e., “Person 1”) and a second person (i.e., “Person 2”) engaged in a conversation having nine (9) time intervals. In this example, a dataset 500 includes data regarding the first person, who is either speaking or making an expression, and the second person, who is either making an ME or speaking. Further, blank squares in the dataset 500 represent time periods in which the person is not speaking, nor making an expression or ME.

In some embodiments, only the human speaking and the expression or ME of a person in response to the articulation is recorded and fed to the model for training. The model is therefore able to detect when expressions and MEs of a person in response to other users on the videoconference are vastly different from previous consistent behavior of that person. The system provides a higher probability of successfully detecting that a person's appearance in a videoconference is deepfaked.

Additional embodiments are provided. In one embodiment, methods and systems are provided for video conferencing software and/or tools to build a deepfake model for each of the participants, using the past videos of the person interacting with other people during video conferencing.

In another embodiment, a person-specific model is trained to detect whether the video of a specific person is deepfaked or not, based on the training data about this person. In an additional embodiment, this person-specific model is fine-tuned on a large model using the training videos of this person.

In one embodiment, the AR glasses have depth sensors equipped, which capture precise 3D models of the individuals' faces, providing an additional layer of identity verification. For example, a deep learning model is provided utilizing 3D information as input to help the appearance and audio models described herein.

In one embodiment, data collection includes any images, videos, and voice available to the system, including at least one of image data, video data, voice data, data available on social media posts, data captured by personal devices like cellphones and digital assistants, data captured in surveillance cameras, data captured in video conferences, combinations of the same, or the like.

In one embodiment, when someone impersonates someone else in a live broadcast on a social media site, e.g., Instagram, and a verification process is failed, the system alerts the real person associated the account of an incident, e.g., that someone is trying to pretend to be that person on the platform.

In another embodiment, a platform of video conferencing, e.g., Zoom, first operates in a verification mode, using a combination of existing signatures and real time data, before permitting a participant to join a Zoom call, admitting the participant in the call, or starting a live broadcast.

In another embodiment, a location is also utilized to prevent fraud. For example, in response to a persistent and/or historic location of the user suddenly changing, the system is configured to further prompt the user with questions and verify, e.g., a change of address. Also, video content captured while the user answers one or more questions is utilized in verification based on the method.

In another embodiment, external data is also utilized to train a model. For example, data collected by one user is shared with other users.

In an additional embodiment, video data collected by one application is shared with other applications. For example, when one application detects a possible fraud, the application is configured to notify other applications about the potential fraud. One or more of the other applications are configured to act regarding an account associated with a user, for example, when it is determined the user is attempting to commit the potential fraud. For example, if FaceTime detects a deepfake video call from one of a plurality of contacts, FaceTime is configured to notify the iMessage application. The iMessage application is configured to take action to flag the suspicious contact as well.

In an additional embodiment, a central authorization service is provided for identity verification. For example, an operating system (e.g., iOS) may be configured such that the authentication service and all applications running or executing on the operating system can utilize the central authorization service. Additionally, data collected from different applications maybe used to train the model.

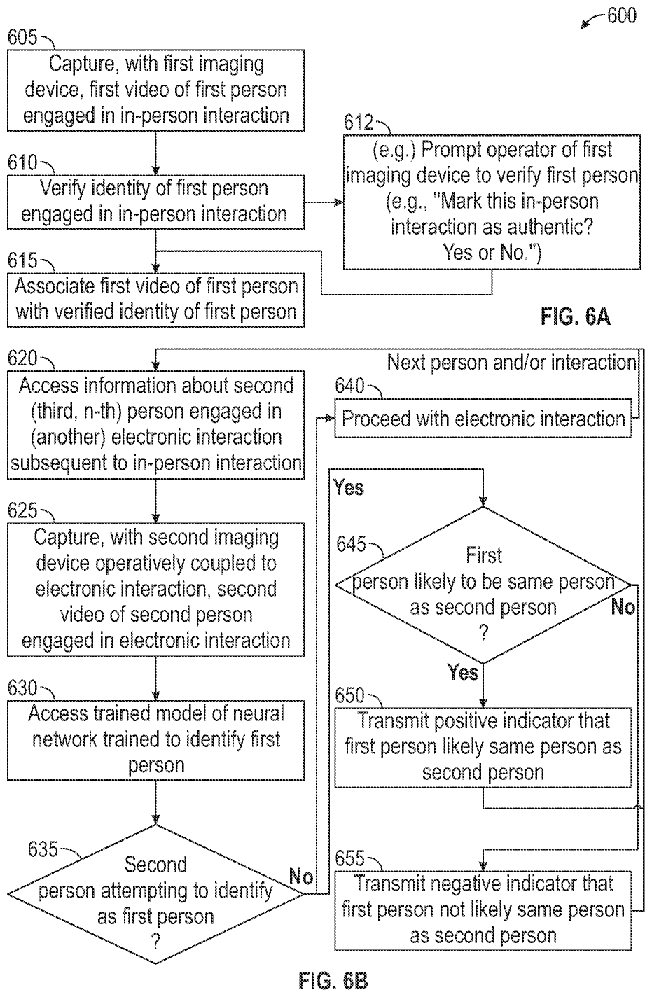

FIG. 6A depicts a process for a learning and/or training phase of identity verification and deepfake prevention for electronic video communication, in accordance with some embodiments of the disclosure. FIG. 6B depicts a process for an inference phase of identity verification and deepfake prevention for electronic video communication, in accordance with some embodiments of the disclosure. In some embodiments, a process 600 for identity verification and deepfake prevention for electronic video communication is provided. In some embodiments, a standalone verification and/or training process begins, for example, at step 605, and the standalone verification and/or training process ends, for example, at step 615. In some embodiments, at a later time, separate from the standalone verification and/or training process, a separate in-conference process begins, for example, at step 620. It is noted that any suitable combination of processes and steps may be provided. For instance, in some embodiments, the process 600 includes all the steps illustrated in FIGS. 6A and 6B.

In some embodiments, as shown in FIG. 6A, the process 600 includes, in some embodiments, during an in-person interaction 105: capturing 605, with a first imaging device 107, 109, 132, a first video of a first person 108 engaged in the in-person interaction 105. For example, the process 600 includes, during an in-person interaction 105: verifying 610 an identity of the first person 108 engaged in the in-person interaction 105. For example, in some embodiments, the verifying 610 the identity of the first person 108 engaged in the in-person interaction 105 includes prompting 612 an operator of the first imaging device 107, 109, 132 to verify the first person 108. For example, during the in-person communication 105, in some embodiments, the prompt for the prompting 612 includes, e.g., “Mark this in-person interaction as authentic? Yes or No.” For example, the process 600 includes, during an in-person interaction 105: associating 615 the first video of the first person 108 with the verified identity of the first person 108.

In some embodiments, as shown in FIG. 6B, the process 600 includes, during an electronic interaction 130, 150, 155 subsequent to the in-person interaction 105: accessing 620 information about a second person 133 engaged in the electronic interaction 130, 150, 155. For example, the process 600 includes capturing 625, with a second imaging device 134 operatively coupled to the electronic interaction 130, 150, 155, a second video of the second person 133 engaged in the electronic interaction 130, 150, 155. For example, the process 600 includes accessing 630 a trained model 125, 253, 256, 259, 1720, 1725 of a neural network trained to identify the first person 108.

For example, the process 600 includes determining 635, with the trained model 125, 253, 256, 259, 1720, 1725, whether the second person 133 is attempting to identify as the first person 108. For example, the process 600 includes in response to determining that the second person 133 is not attempting to identify as the first person 108 (635=“No”): proceeding 640 with the electronic interaction 130, 150, 155. For example, the process 600 includes accessing 620 information about a third person (an n-th person, and so on) engaged in another electronic interaction.

For example, the process 600 includes, in response to determining that the second person 133 is attempting to identify as the first person 108 (635=“Yes”): determining 645, with the trained model 125, 253, 256, 259, 1720, 1725, whether the first person 108 is likely to be a same person as the second person 133. For example, the process 600 includes in response to determining the first person 108 is likely to be the same person as the second person 133 (645=“Yes”): transmitting 650 a positive indicator 152 that the first person 108 is likely to be the same person as the second person 133. For example, the process 600 includes accessing 620 information about a third person (an n-th person, and so on) engaged in another electronic interaction.

For example, the process 600 includes in response to determining the first person 108 is not likely to be the same person as the second person 133 (645=“No”): transmitting 655 a negative indicator 157 that the first person 108 is not likely to be the same person as the second person 133.

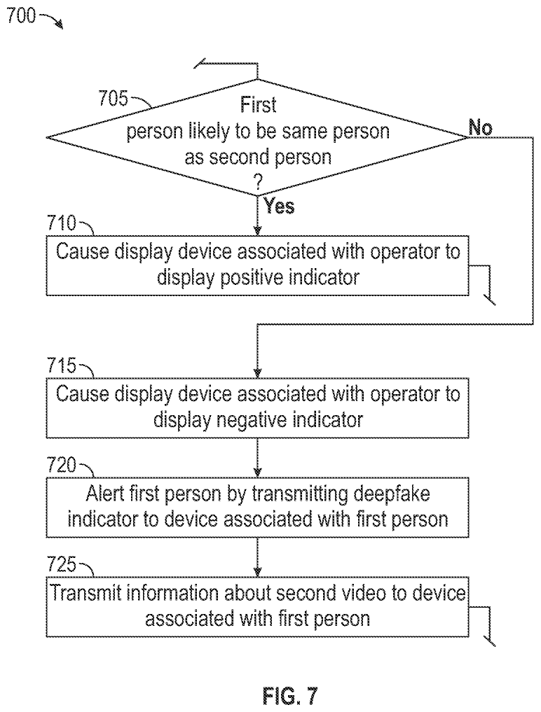

FIG. 7 depicts a process 700 for identity verification and deepfake prevention for electronic video communication, in accordance with some embodiments of the disclosure. For example, the process 700 includes, in response to determining 705 the first person 108 is likely to be the same person as the second person 133 (705=“Yes”): causing 710 a display device 151 associated with an operator to display the positive indicator 152.

For example, the process 700 includes, in response to determining 705 the first person 108 is not likely to be the same person as the second person 133 (705=“No”): causing 715 the display device 151 associated with the operator to display the negative indicator 157. For example, the process 700 includes alerting 720 the first person 108 by transmitting a deepfake indicator to a device associated with the first person 108. For example, the process 700 includes transmitting 725 information about the second video to the device associated with the first person 108.

In some embodiments, the first imaging device 107, 109, 132 is a wearable device. For example, the wearable device is at least one of augmented reality glasses, mixed reality glasses, a light field camera, a volumetric capture device, a depth-sensing camera, a smartphone, combinations of the same, or the like.

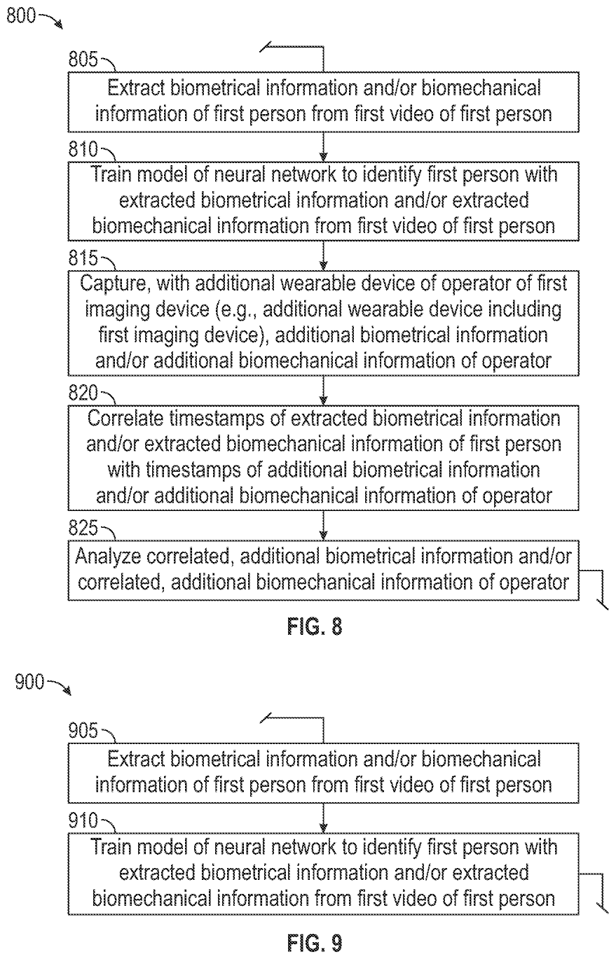

FIG. 8 depicts a process 800 for identity verification and deepfake prevention for electronic video communication, in accordance with some embodiments of the disclosure. For example, the process 800 includes extracting 805 biometrical information 110 and/or biomechanical information 115 of the first person 108 from the first video of the first person 108. For example, the process 800 includes training 810 the model 125, 253, 256, 259, 1720, 1725 of the neural network to identify the first person 108 with the extracted biometrical information 110 and/or the extracted biomechanical information 115 from the first video of the first person 108.

For example, the process 800 includes capturing 815, with an additional wearable device of an operator of the first imaging device 107, 109, 132, additional biometrical information and/or additional biomechanical information of the operator. For example, in some embodiments, the additional wearable device includes the first imaging device 107, 109, 132. For example, the process 800 includes correlating 820 timestamps of the extracted biometrical information and/or the extracted biomechanical information of the first person 108 with timestamps of the additional biometrical information and/or the additional biomechanical information of the operator.

In some embodiments, training 810 of the trained model 125, 253, 256, 259, 1720, 1725 of the neural network trained to identify the first person 108 with the extracted biometrical information and/or the extracted biomechanical information includes analyzing 825 the correlated, additional biometrical information and/or the correlated, additional biomechanical information of the operator.

In some embodiments, the additional wearable device is at least one of augmented reality glasses, mixed reality glasses, a light field camera, a volumetric capture device, a depth-sensing camera, a smartphone, a smart watch, a smart ring, combinations of the same, or the like. In some embodiments, instead of capturing a video of the first person, a message is sent to the AR glasses of the first person to record time-series sensor data. The data is, for example, provided directly by the AR glasses of the first person to the training model with a label that this interaction was audience-specific, e.g., the interaction was an interaction with an operator of the AR glasses.

FIG. 9 depicts a process 900 for identity verification and deepfake prevention for electronic video communication, in accordance with some embodiments of the disclosure. For example, the process 900 includes extracting 905 biometrical information and/or biomechanical information of the first person 108 from the first video of the first person 108. For example, the process 900 includes training 910 the model 125, 253, 256, 259, 1720, 1725 of the neural network to identify the first person 108 with the extracted biometrical information and/or the extracted biomechanical information from the first video of the first person 108. In some embodiments, the biometrical information and/or the biomechanical information includes information based on at least one of behavioral profiling, face recognition, gait, hand geometry, iris recognition, palm veins, retina recognition, a shape of ears, vocal biometrics, voice recognition, combinations of the same, or the like.

In some embodiments, the biomechanical information includes information based on at least one of arm movement analysis, eye movement analysis, finger movement analysis, gait analysis, hand movement analysis, head movement analysis, kinematics, markerless motion capture, posture analysis, combinations of the same, or the like.

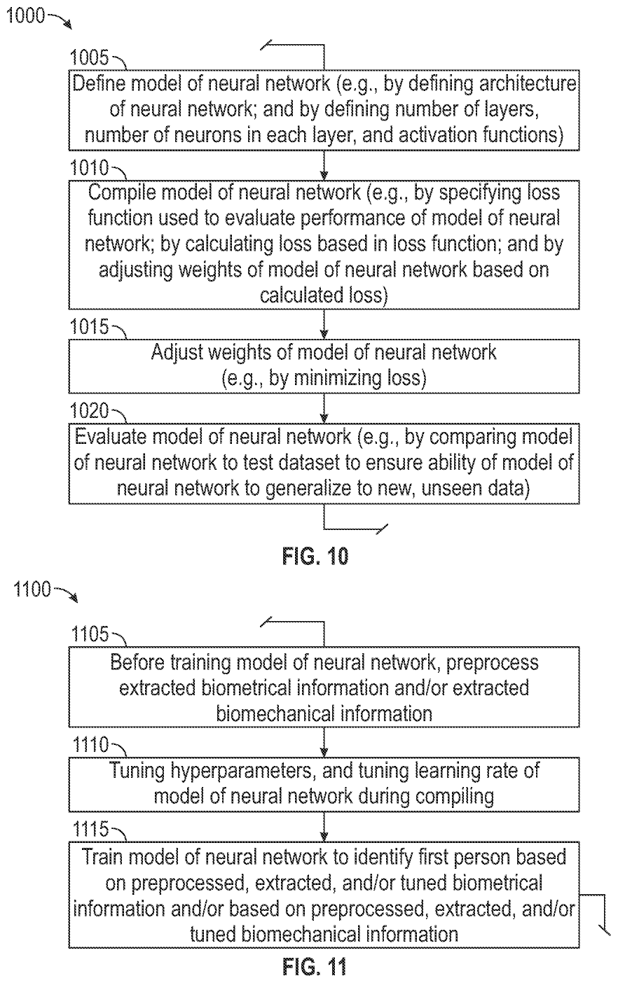

FIG. 10 depicts a process 1000 for identity verification and deepfake prevention for electronic video communication, in accordance with some embodiments of the disclosure. For example, the process 1000 includes defining 1005 the model 125, 253, 256, 259, 1720, 1725 of the neural network. For example, the process 1000 includes compiling 1010 the model 125, 253, 256, 259, 1720, 1725 of the neural network. For example, the process 1000 includes adjusting 1015 the weights of the model 125, 253, 256, 259, 1720, 1725 of the neural network. For example, the process 1000 includes evaluating 1020 the model 125, 253, 256, 259, 1720, 1725 of the neural network.

FIG. 11 depicts a process 1100 for identity verification and deepfake prevention for electronic video communication, in accordance with some embodiments of the disclosure. For example, the process 1100 includes before training the model 125, 253, 256, 259, 1720, 1725 of the neural network, preprocessing 1105 the extracted biometrical information and/or the extracted biomechanical information. For example, in some embodiments, the process 1100 includes tuning 1110 hyperparameters, and tuning a learning rate of the model 125, 253, 256, 259, 1720, 1725 of the neural network during the compiling. In some embodiments, training 1115 of the model 125, 253, 256, 259, 1720, 1725 of the neural network to identify the first person 108 is based on the preprocessed, extracted biometrical information and/or the preprocessed, extracted biomechanical information. In some embodiments, the training 1115 of the model 125, 253, 256, 259, 1720, 1725 of the neural network to identify the first person 108 is based on the preprocessed, extracted, and tuned biometrical information and/or the preprocessed, extracted, and tuned biomechanical information.

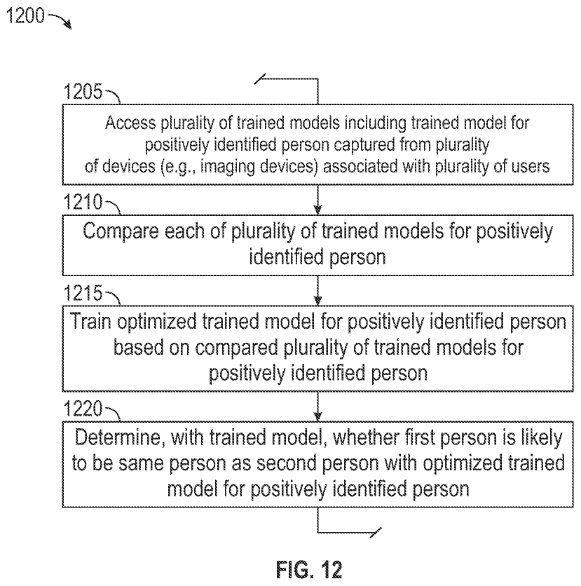

FIG. 12 depicts a process 1200 for identity verification and deepfake prevention for electronic video communication, in accordance with some embodiments of the disclosure. For example, the process 1200 includes accessing 1205 a plurality of trained models including the trained model 125, 253, 256, 259, 1720, 1725 for a positively identified person captured from a plurality of devices (e.g., imaging devices, and/or sensor devices, combinations of the same, or the like) associated with a plurality of users. For example, the process 1200 includes comparing 1210 each of the plurality of trained models for the positively identified person. For example, the process 1200 includes training 1215 an optimized trained model 125, 253, 256, 259, 1720, 1725 for the positively identified person based on the compared plurality of trained models for the positively identified person. For example, the process 1200 includes determining 1220, with the trained model 125, 253, 256, 259, 1720, 1725, whether the first person 108 is likely to be the same person as the second person 133 is performed with the optimized trained model 125, 253, 256, 259, 1720, 1725 for the positively identified person.

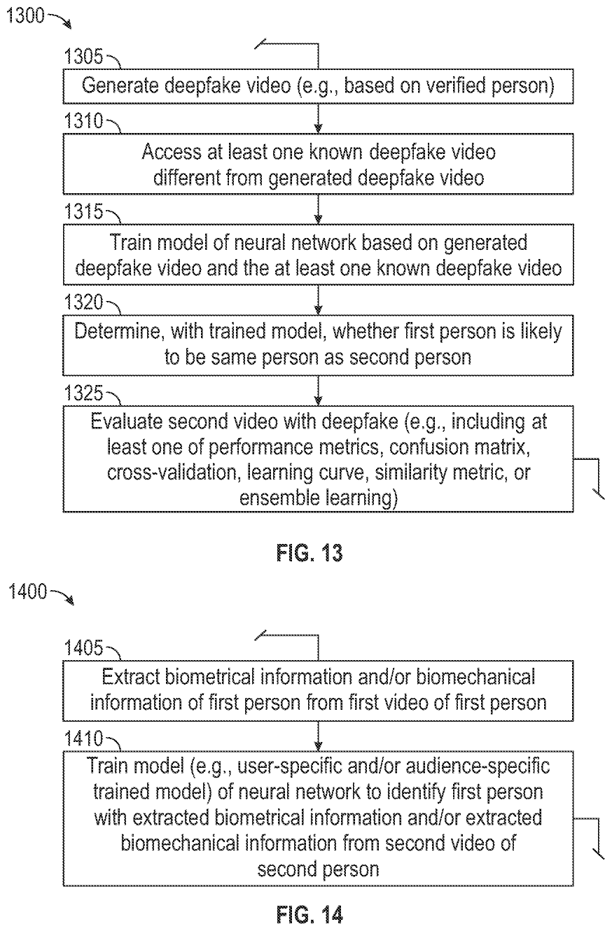

FIG. 13 depicts a process 1300 for identity verification and deepfake prevention for electronic video communication, in accordance with some embodiments of the disclosure. For example, the process 1300 includes generating 1305 a deepfake video based on the first person after verifying the identity of the first person. For example, the process 1300 includes accessing 1310 at least one known deepfake video different from the generated deepfake video. For example, the process 1300 includes training 1315 the model 125, 253, 256, 259, 1720, 1725 of the neural network based on the generated deepfake video and the at least one known deepfake video. For example, the process 1300 includes determining 1320, with the trained model 125, 253, 256, 259, 1720, 1725, whether the first person 108 is likely to be the same person as the second person 133. For example, the process 1300 includes evaluating 1325 the second video with the model 125, 253, 256, 259, 1720, 1725. For example, the process 1300 includes evaluating 1330 the second video with the model 125, 253, 256, 259, 1720, 1725 including at least one of performance metrics, a confusion matrix, cross-validation, a learning curve, a similarity metric, ensemble learning, combinations of the same, or the like.

A process is provided for identity verification and deepfake prevention for electronic video communication, in accordance with some embodiments of the disclosure. For example, the process includes accessing a known deepfake video. For example, the process includes accessing at least one negative sample (e.g., a plurality of negative samples) from the known deepfake video. For example, the process includes training the model 125, 253, 256, 259, 1720, 1725 of the neural network based on the at least one negative sample from the known deepfake video. For example, the process includes determining, with the trained model 125, 253, 256, 259, 1720, 1725, whether the first person 108 is likely to be the same person as the second person 133. For example, the process includes evaluating the second video with the model 125, 253, 256, 259, 1720, 1725. For example, the process includes evaluating the second video with the model 125, 253, 256, 259, 1720, 1725 including at least one of performance metrics, a confusion matrix, cross-validation, a learning curve, a similarity metric, ensemble learning, combinations of the same, or the like.

FIG. 14 depicts a process 1400 for identity verification and deepfake prevention for electronic video communication, in accordance with some embodiments of the disclosure. For example, the process 1400 includes extracting 1405 biometrical information and/or biomechanical information of the first person 108 from the first video of the first person 108. For example, the process 1400 includes training 1410 a model 125, 253, 256, 259, 1720, 1725 of a neural network to identify the first person 108 with the extracted biometrical information and/or the extracted biomechanical information from the second video of the second person 133. In some embodiments, the trained model 125, 253, 256, 259, 1720, 1725 of the neural network trained to identify the first person 108 with the extracted biometrical information and/or the extracted biomechanical information is a user-specific and/or audience-specific trained model 125, 253, 256, 259, 1720, 1725.

### Predictive Model

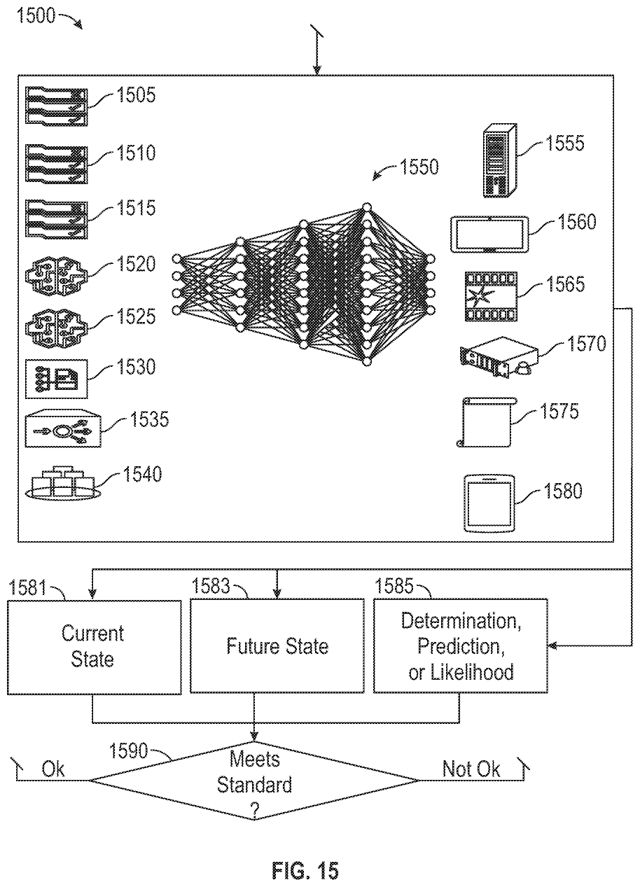

Throughout the present disclosure, in some embodiments, determinations, predictions, likelihoods, and the like are determined with one or more predictive models. For example, FIG. 15 depicts a predictive model. A prediction process 1500 includes a predictive model 1550 in some embodiments. The predictive model 1550 receives as input various forms of data about one, more or all the users, media content items, devices, and data described in the present disclosure. The predictive model 1550 performs analysis based on at least one of hard rules, learning rules, hard models, learning models, usage data, load data, analytics of the same, metadata, profile information, combinations of the same, or the like. The predictive model 1550 outputs one or more predictions of a future state of any of the devices described in the present disclosure. A load-increasing event is determined by load-balancing processes, e.g., least connection, least bandwidth, round robin, server response time, weighted versions of the same, resource-based processes, and address hashing. The predictive model 1550 is based on input including at least one of a hard rule 1505, a user-defined rule 1510, a rule defined by a content provider 1515, a hard model 1520, a learning model 1525, combinations of the same, or the like.

The predictive model 1550 receives as input usage data 1530. The predictive model 1550 is based, in some embodiments, on at least one of a usage pattern of the user or media device, a usage pattern of the requesting media device, a usage pattern of the media content item, a usage pattern of the communication system or network, a usage pattern of the profile, a usage pattern of the media device, combinations of the same, or the like.

The predictive model 1550 receives as input load-balancing data 1535. The predictive model 1550 is based on at least one of load data of the display device, load data of the requesting media device, load data of the media content item, load data of the communication system or network, load data of the profile, load data of the media device, combinations of the same, or the like.

The predictive model 1550 receives as input metadata 1540. The predictive model 1550 is based on at least one of metadata of the streaming service, metadata of the requesting media device, metadata of the media content item, metadata of the communication system or network, metadata of the profile, metadata of the media device, combinations of the same, or the like. The metadata includes information of the type represented in the media device manifest.

The predictive model 1550 is trained with data. The training data is developed in some embodiments using one or more data processes including but not limited to data selection, data sourcing, and data synthesis. The predictive model 1550 is trained in some embodiments with one or more analytical processes including but not limited to classification and regression trees (CART), discrete choice models, linear regression models, logistic regression, logit versus probit, multinomial logistic regression, multivariate adaptive regression splines, probit regression, regression processes, survival or duration analysis, and time series models. The predictive model 1550 is trained in some embodiments with one or more machine learning approaches including but not limited to supervised learning, unsupervised learning, semi-supervised learning, reinforcement learning, and dimensionality reduction. The predictive model 1550 in some embodiments includes regression analysis including analysis of variance (ANOVA), linear regression, logistic regression, ridge regression, and/or time series. The predictive model 1550 in some embodiments includes classification analysis including decision trees and/or neural networks. In FIG. 15, a depiction of a multi-layer neural network is provided as a non-limiting example of a predictive model 1550, the neural network including an input layer (left side), three hidden layers (middle), and an output layer (right side) with 32 neurons and 192 edges, which is intended to be illustrative, not limiting. The predictive model 1550 is based on data engineering and/or modeling processes. The data engineering processes include exploration, cleaning, normalizing, feature engineering, and scaling. The modeling processes include model selection, training, evaluation, and tuning. The predictive model 1550 is operationalized using registration, deployment, monitoring, and/or retraining processes.

The predictive model 1540 is configured to output results to a device, or multiple devices. The device includes means for performing one, more, or all the features referenced herein of the systems, methods, processes, inputs, and outputs of one or more of FIGS. 1-16, in any suitable combination. The device is at least one of a server 1555, a tablet 1560, a media display device 1565, a network-connected computer 1570, a media device 1575, a computing device 1580, combinations of the same, or the like.

The predictive model 1550 is configured to output a current state 1581, and/or a future state 1583, and/or a determination, a prediction, or a likelihood 1585, and the like. The current state 1581, and/or the future state 1583, and/or the determination, the prediction, or the likelihood 1585, and the like may be compared 1590 to a predetermined or determined standard. In some embodiments, the standard is satisfied (1490=OK) or rejected (1490=NOT OK). If the standard is satisfied or rejected, the predictive process 1500 outputs at least one of the current state, the future state, the determination, the prediction, the likelihood to any device or module disclosed herein, combinations of the same, or the like.

### Communication System

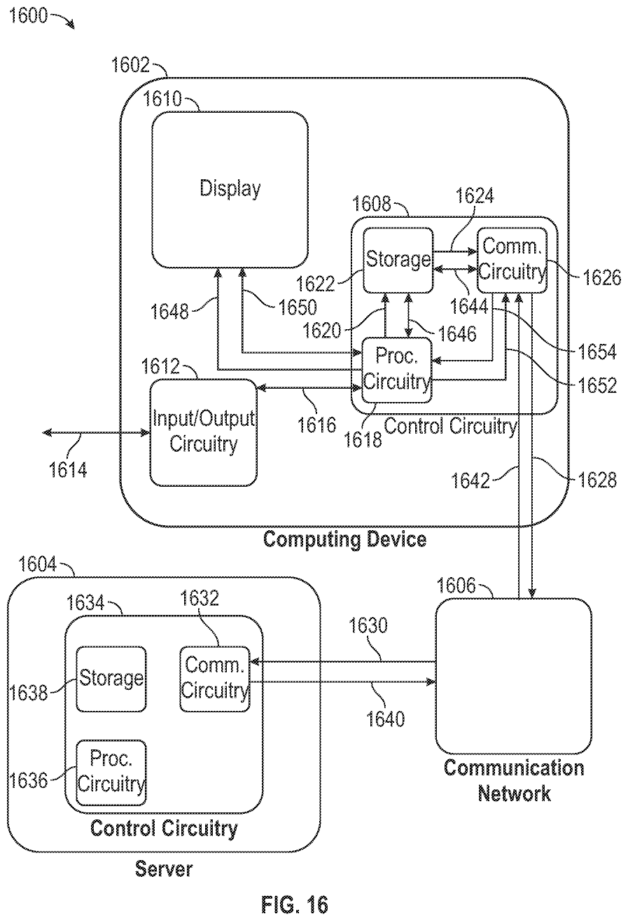

FIG. 16 depicts a block diagram of system 1600, in accordance with some embodiments. The system is shown to include computing device 1602, server 1604, and a communication network 1606. It is understood that while a single instance of a component may be shown and described relative to FIG. 16, additional embodiments of the component may be employed. For example, server 1604 may include, or may be incorporated in, more than one server. Similarly, communication network 1606 may include, or may be incorporated in, more than one communication network. Server 1604 is shown communicatively coupled to computing device 1602 through communication network 1606. While not shown in FIG. 16, server 1604 may be directly communicatively coupled to computing device 1602, for example, in a system absent or bypassing communication network 1606.

Communication network 1606 may include one or more network systems, such as, without limitation, the Internet, LAN, Wi-Fi, wireless, or other network systems suitable for audio processing applications. The system 1600 of FIG. 16 excludes server 1604, and functionality that would otherwise be implemented by server 1604 is instead implemented by other components of the system depicted by FIG. 16, such as one or more components of communication network 1606. In still other embodiments, server 1604 works in conjunction with one or more components of communication network 1606 to implement certain functionality described herein in a distributed or cooperative manner. Similarly, the system depicted by FIG. 16 excludes computing device 1602, and functionality that would otherwise be implemented by computing device 1602 is instead implemented by other components of the system depicted by FIG. 16, such as one or more components of communication network 1606 or server 1604 or a combination of the same. In other embodiments, computing device 1602 works in conjunction with one or more components of communication network 1606 or server 1604 to implement certain functionality described herein in a distributed or cooperative manner.

Computing device 1602 includes control circuitry 1608, display 1610 and input/output (I/O) circuitry 1612. Control circuitry 1608 may be based on any suitable processing circuitry and includes control circuits and memory circuits, which may be disposed on a single integrated circuit or may be discrete components. As referred to herein, processing circuitry should be understood to mean circuitry based on at least one microprocessors, microcontrollers, digital signal processors, programmable logic devices, field-programmable gate arrays (FPGAs), application-specific integrated circuits (ASICs), system-on-chip (SoC), application-specific standard parts (ASSPs), indium phosphide (InP)-based monolithic integration and silicon photonics, non-classical devices, organic semiconductors, compound semiconductors, “More Moore” devices, “More than Moore” devices, cloud-computing devices, combinations of the same, or the like, and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i7 processor and an Intel Core i9 processor). Some control circuits may be implemented in hardware, firmware, or software. Control circuitry 1608 in turn includes communication circuitry 1626, storage 1622 and processing circuitry 1618. Either of control circuitry 1608 and 1634 may be utilized to execute or perform any or all the systems, methods, processes, inputs, and outputs of one or more of FIGS. 1A-14, or any combination of steps thereof (e.g., as enabled by processing circuitries 1618 and 1636, respectively).

In addition to control circuitry 1608 and 1634, computing device 1602 and server 1604 may each include storage (storage 1622, and storage 1638, respectively). Each of storages 1618 and 1638 may be an electronic storage device. As referred to herein, the phrase “electronic storage device” or “storage device” should be understood to mean any device for storing electronic data, computer software, or firmware, such as random-access memory, read-only memory, cloud-based storage, hard drives, optical drives, digital video disc (DVD) recorders, compact disc (CD) recorders, BLU-RAY disc (BD) recorders, BLU-RAY 8D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 1622 and 1638 may be used to store several types of content, metadata, and/or other types of data. Non-volatile memory may also be used (e.g., to launch a boot-up routine and other instructions). Cloud-based storage may be used to supplement storages 1618 and 1638 or instead of storages 1618 and 1638. In some embodiments, a user profile and messages corresponding to a chain of communication may be stored in one or more of storages 1618 and 1638. Each of storages 1618 and 1638 may be utilized to store commands, for example, such that when each of processing circuitries 1618 and 1636, respectively, are prompted through control circuitries 1608 and 1634, respectively. Either of processing circuitries 1618 or 1636 may execute any of the systems, methods, processes, inputs, and outputs of one or more of FIGS. 1A-14, or any combination of steps thereof.

In some embodiments, control circuitry 1608 and/or 1634 executes instructions for an application stored in memory (e.g., storage 1622 and/or storage 1638). Specifically, control circuitry 1608 and/or 1634 may be instructed by the application to perform the functions discussed herein. In some embodiments, any action performed by control circuitry 1608 and/or 1634 may be based on instructions received from the application. For example, the application may be implemented as software or a set of and/or one or more executable instructions that may be stored in storage 1622 and/or 1638 and executed by control circuitry 1608 and/or 1634. The application may be a client/server application where only a client application resides on computing device 1602, and a server application resides on server 1604.

The application may be implemented using any suitable architecture. For example, it may be a stand-alone application wholly implemented on computing device 1602. In such an approach, instructions for the application are stored locally (e.g., in storage 1622), and data for use by the application is downloaded on a periodic basis (e.g., from an out-of-band feed, from an Internet resource, or using another suitable approach). Control circuitry 1608 may retrieve instructions for the application from storage 1622 and process the instructions to perform the functionality described herein. Based on the processed instructions, control circuitry 1608 may determine a type of action to perform in response to input received from I/O circuitry 1612 or from communication network 1606.

The computing device 1602 is configured to communicate with an I/O device via the I/O circuitry 1612. The I/O device includes any suitable device. In some embodiments, the user input 1614 is received from the I/O device. A wired and/or wireless connection between the I/O circuitry 1612 and the I/O device is provided in some embodiments.

In client/server-based embodiments, control circuitry 1608 may include communication circuitry suitable for communicating with an application server (e.g., server 1604) or other networks or servers. The instructions for conducting the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication network 1606). In another example of a client/server-based application, control circuitry 1608 runs a web browser that interprets web pages provided by a remote server (e.g., server 1604). For example, the remote server may store the instructions for the application in a storage device.

The remote server may process the stored instructions using circuitry (e.g., control circuitry 1634) and/or generate displays. Computing device 1602 may receive the displays generated by the remote server and may display the content of the displays locally via display 1610. For example, display 1610 may be utilized to present a string of characters. This way, the processing of the instructions is performed remotely (e.g., by server 1604) while the resulting displays, such as the display windows described elsewhere herein, are provided locally on computing device 1604. Computing device 1602 may receive inputs from the user via input/output circuitry 1612 and transmit those inputs to the remote server for processing and generating the corresponding displays.

Alternatively, computing device 1602 may receive inputs from the user via input/output circuitry 1612 and process and display the received inputs locally, by control circuitry 1608 and display 1610, respectively. For example, input/output circuitry 1612 may correspond to a keyboard and/or a set of and/or one or more speakers/microphones which are used to receive user inputs (e.g., input as displayed in a search bar or a display of FIG. 16 on a computing device). Input/output circuitry 1612 may also correspond to a communication link between display 1610 and control circuitry 1608 such that display 1610 updates in response to inputs received via input/output circuitry 1612 (e.g., simultaneously update what is shown in display 1610 based on inputs received by generating corresponding outputs based on instructions stored in memory via a non-transitory, computer-readable medium).

Server 1604 and computing device 1602 may transmit and receive content and data such as media content via communication network 1606. For example, server 1604 may be a media content provider, and computing device 1602 may be a smart television configured to download or stream media content, such as a live news broadcast, from server 1604. Control circuitry 1634, 1608 may send and receive commands, requests, and other suitable data through communication network 1606 using communication circuitry 1632, 1626, respectively. Alternatively, control circuitry 1634, 1608 may communicate directly with each other using communication circuitry 1632, 1626, respectively, avoiding communication network 1606.

It is understood that computing device 1602 is not limited to the embodiments and methods shown and described herein. In nonlimiting examples, computing device 1602 may be a television, a Smart TV, a set-top box, an integrated receiver decoder (IRD) for controlling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, computing equipment, or wireless device, and/or combination of the same, capable of suitably displaying and manipulating media content.

Computing device 1602 receives user input 1614 at input/output circuitry 1612. For example, computing device 1602 may receive a user input such as a user swipe or user touch. It is understood that computing device 1602 is not limited to the embodiments and methods shown and described herein.

User input 1614 may be received from a user selection-capturing interface that is separate from device 1602, such as a remote-control device, trackpad, or any other suitable user movement-sensitive, audio-sensitive or capture devices, or as part of device 1602, such as a touchscreen of display 1610. Transmission of user input 1614 to computing device 1602 may be accomplished using a wired connection, such as an audio cable, USB cable, ethernet cable and the like attached to a corresponding input port at a local device, or may be accomplished using a wireless connection, such as Bluetooth, Wi-Fi, WiMAX, GSM, UTMS, CDMA, TDMA, 8G, 4G, 4G LTE, 5G, NearLink, ultra-wideband technology, or any other suitable wireless transmission protocol. Input/output circuitry 1612 may include a physical input port such as a 12.5 mm (0.4921 inch) audio jack, RCA audio jack, USB port, ethernet port, or any other suitable connection for receiving audio over a wired connection or may include a wireless receiver configured to receive data via Bluetooth, Wi-Fi, WiMAX, GSM, UTMS, CDMA, TDMA, 3G, 4G, 4G LTE, 5G, NearLink, ultra-wideband technology, or other wireless transmission protocols.

Processing circuitry 1618 may receive user input 1614 from input/output circuitry 1612 using communication path 1616. Processing circuitry 1618 may convert or translate the received user input 1614 that may be in the form of audio data, visual data, gestures, or movement to digital signals. In some embodiments, input/output circuitry 1612 performs the translation to digital signals. In some embodiments, processing circuitry 1618 (or processing circuitry 1636, as the case may be) conducts disclosed processes and methods.

Processing circuitry 1618 may provide requests to storage 1622 by communication path 1620. Storage 1622 may provide requested information to processing circuitry 1618 by communication path 1646. Storage 1622 may transfer a request for information to communication circuitry 1626 which may translate or encode the request for information to a format receivable by communication network 1606 before transferring the request for information by communication path 1628. Communication network 1606 may forward the translated or encoded request for information to communication circuitry 1632, by communication path 1630.

At communication circuitry 1632, the translated or encoded request for information, received through communication path 1630, is translated or decoded for processing circuitry 1636, which will provide a response to the request for information based on information available through control circuitry 1634 or storage 1638, or a combination thereof. The response to the request for information is then provided back to communication network 1606 by communication path 1640 in an encoded or translated format such that communication network 1606 forwards the encoded or translated response back to communication circuitry 1626 by communication path 1642.

At communication circuitry 1626, the encoded or translated response to the request for information may be provided directly back to processing circuitry 1618 by communication path 1654 or may be provided to storage 1622 through communication path 1644, which then provides the information to processing circuitry 1618 by communication path 1646. Processing circuitry 1618 may also provide a request for information directly to communication circuitry 1626 through communication path 1652, where storage 1622 responds to an information request (provided through communication path 1620 or 1644) by communication path 1624 or 1646 that storage 1622 does not contain information pertaining to the request from processing circuitry 1618.

Processing circuitry 1618 may process the response to the request received through communication paths 1646 or 1654 and may provide instructions to display 1610 for a notification to be provided to the users through communication path 1648. Display 1610 may incorporate a timer for providing the notification or may rely on inputs through input/output circuitry 1612 from the user, which are forwarded through processing circuitry 1618 through communication path 1648, to determine how long or in what format to provide the notification. When display 1610 determines the display has been completed, a notification may be provided to processing circuitry 1618 through communication path 1650.

The communication paths provided in FIG. 16 between computing device 1602, server 1604, communication network 1606, and all subcomponents depicted are examples and may be modified to reduce processing time or enhance processing capabilities for each step in the processes disclosed herein by one skilled in the art.

### Terminology

The terminology used herein is for the purpose of describing particular embodiments only and is not intended to be limiting of the disclosure.

As used herein, the terms “real time,” “simultaneous,” “substantially on-demand,” and the like are understood to be nearly instantaneous but may include delay due to practical limits of the system. Such delays may be in the order of milliseconds, microseconds or less, depending on the application and nature of the processing. Relatively longer delays (e.g., greater than a millisecond) may result due to communication or processing delays, particularly in remote and cloud computing environments.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although at least some embodiments are described as using a plurality of units or modules to perform a process or processes, it is understood that the process or processes may also be performed by one or a plurality of units or modules. Additionally, it is understood that the term controller/control unit may refer to a hardware device that includes a memory and a processor. The memory may be configured to store the units or the modules, and the processor may be specifically configured to execute said units or modules to perform one or more processes which are described herein.

Unless specifically stated or obvious from context, as used herein, the term “about” is understood as within a range of normal tolerance in the art, for example within 2 standard deviations of the mean. “About” may be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The use of the terms “first”, “second”, “third”, and so on, herein, are provided to identify structures or operations, without describing an order of structures or operations, and, to the extent the structures or operations are used in an embodiment, the structures may be provided or the operations may be executed in a different order from the stated order unless a specific order is definitely specified in the context.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory (e.g., a non-transitory, computer-readable medium accessible by an application via control or processing circuitry from storage) including, but not limited to, volatile and non-volatile computer memory or storage devices such as a hard disk, floppy disk, USB drive, DVD, CD, media cards, register memory, processor caches, random access memory (RAM), UltraRAM, cloud-based storage, and the like.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

Any use of a phrase such as “in some embodiments” or the like with reference to a feature is not intended to link the feature to another feature described using the same or a similar phrase. Any and all embodiments disclosed herein are combinable or separately practiced as appropriate. Absence of the phrase “in some embodiments” does not infer that the feature is necessary. Inclusion of the phrase “in some embodiments” does not infer that the feature is not applicable to other embodiments or even all embodiments.

The systems and processes discussed herein are intended to be illustrative and not limiting. One skilled in the art would appreciate that the actions of the processes discussed herein may be omitted, modified, combined, duplicated, rearranged, and/or substituted, and any additional actions may be performed without departing from the scope of the invention. More generally, the disclosure herein is meant to provide examples and is not limiting. Only the claims that follow are meant to set bounds as to what the present disclosure includes. Furthermore, it should be noted that the features and limitations described in any some embodiments may be applied to any other embodiment herein, and flowcharts or examples relating to some embodiments may be combined with any other embodiment in a suitable manner, done in different orders, or done in parallel. In addition, the methods and systems described herein may be performed in real time. It should also be noted that the methods and/or systems described herein may be applied to, or used in accordance with, other methods and/or systems.

This description is to be taken only by way of example and not to otherwise limit the scope of the embodiments herein. Therefore, it is the object of the appended claims to cover all such variations and modifications as come within the true spirit and scope of the embodiments herein.

1. A method for identity verification and deepfake prevention for electronic video communication, the method comprising:
during an in-person interaction:
capturing, with a first imaging device, a first video of a first person engaged in the in-person interaction;
verifying an identity of the first person engaged in the in-person interaction;
associating the first video of the first person with the verified identity of the first person; and
during an electronic interaction subsequent to the in-person interaction:
accessing information about a second person engaged in the electronic interaction;
capturing, with a second imaging device operatively coupled to the electronic interaction, a second video of the second person engaged in the electronic interaction;
accessing a trained model of a neural network trained to identify the first person;
determining, with the trained model, whether the second person is attempting to identify as the first person;
in response to determining that the second person is not attempting to identify as the first person:
proceeding with the electronic interaction; and
in response to determining that the second person is attempting to identify as the first person:
determining, with the trained model, whether the first person is likely to be a same person as the second person;
in response to determining the first person is likely to be the same person as the second person:
transmitting a positive indicator that the first person is likely to be the same person as the second person; and
in response to determining the first person is not likely to be the same person as the second person:
transmitting a negative indicator that the first person is not likely to be the same person as the second person.

2. The method of claim 1, comprising:
in response to determining the first person is likely to be the same person as the second person:
causing a display device associated with an operator to display the positive indicator; and
in response to determining the first person is not likely to be the same person as the second person:
causing the display device associated with the operator to display the negative indicator;
alerting the first person by transmitting a deepfake indicator to a device associated with the first person; and
transmitting information about the second video to the device associated with the first person.

3. The method of claim 1, wherein the first imaging device is a wearable device.

4. The method of claim 3, wherein the wearable device is at least one of augmented reality glasses, mixed reality glasses, a light field camera, a volumetric capture device, a depth-sensing camera, or a smartphone.

5. The method of claim 1, comprising:
extracting biometrical information and/or biomechanical information of the first person from the first video of the first person; and
training the model of the neural network to identify the first person with the extracted biometrical information and/or the extracted biomechanical information from the first video of the first person;
capturing, with an additional wearable device of an operator of the first imaging device, wherein the additional wearable device includes the first imaging device, additional biometrical information and/or additional biomechanical information of the operator; and
correlating timestamps of the extracted biometrical information and/or the extracted biomechanical information of the first person with timestamps of the additional biometrical information and/or the additional biomechanical information of the operator,
wherein the trained model of the neural network trained to identify the first person with the extracted biometrical information and/or the extracted biomechanical information includes analyzing the correlated, additional biometrical information and/or the correlated, additional biomechanical information of the operator.

6. The method of claim 5, wherein the additional wearable device is at least one of augmented reality glasses, mixed reality glasses, a light field camera, a volumetric capture device, a depth-sensing camera, a smartphone, a smart watch, or a smart ring.

7. The method of claim 1, wherein the verifying the identity of the first person engaged in the in-person interaction includes prompting an operator of the first imaging device to verify the first person.

8. The method of claim 1, comprising:
extracting biometrical information and/or biomechanical information of the first person from the first video of the first person; and
training the model of the neural network to identify the first person with the extracted biometrical information and/or the extracted biomechanical information from the first video of the first person,
wherein the biometrical information and/or the biomechanical information includes information based on at least one of behavioral profiling, face recognition, gait, hand geometry, iris recognition, palm veins, retina recognition, a shape of ears, vocal biometrics, or voice recognition.

9. The method of claim 1, wherein the biomechanical information includes information based on at least one of arm movement analysis, eye movement analysis, finger movement analysis, gait analysis, hand movement analysis, head movement analysis, kinematics, markerless motion capture, or posture analysis.

10. The method of claim 1, comprising:
extracting biometrical information and/or biomechanical information of the first person from the first video of the first person; and
training the model of the neural network to identify the first person with the extracted biometrical information and/or the extracted biomechanical information of the first person from the first video.

11.-20. (canceled)

21. A system for identity verification and deepfake prevention for electronic video communication, the system comprising:
a communication port;
a memory storing instructions; and
control circuitry communicably coupled to the memory and the communication port and configured to execute the instructions to:
during an in-person interaction:
capture, with a first imaging device, a first video of a first person engaged in the in-person interaction;
verify an identity of the first person engaged in the in-person interaction;
associate the first video of the first person with the verified identity of the first person; and
during an electronic interaction subsequent to the in-person interaction:
access information about a second person engaged in the electronic interaction;
capture, with a second imaging device operatively coupled to the electronic interaction, a second video of the second person engaged in the electronic interaction;
access a trained model of a neural network trained to identify the first person;
determine, with the trained model, whether the second person is attempting to identify as the first person;
in response to determining that the second person is not attempting to identify as the first person:
proceed with the electronic interaction; and
in response to determining that the second person is attempting to identify as the first person:
determine, with the trained model, whether the first person is likely to be a same person as the second person;
in response to determining the first person is likely to be the same person as the second person:
transmit a positive indicator that the first person is likely to be the same person as the second person; and
in response to determining the first person is not likely to be the same person as the second person:
transmit a negative indicator that the first person is not likely to be the same person as the second person.

22. The system of claim 21, wherein the control circuitry is configured to execute the instructions to:
in response to determining the first person is likely to be the same person as the second person:
cause a display device associated with an operator to display the positive indicator; and
in response to determining the first person is not likely to be the same person as the second person:
cause the display device associated with the operator to display the negative indicator;
alert the first person by transmitting a deepfake indicator to a device associated with the first person; and
transmit information about the second video to the device associated with the first person.

23. The system of claim 21, wherein the first imaging device is a wearable device.

24. The system of claim 23, wherein the wearable device is at least one of augmented reality glasses, mixed reality glasses, a light field camera, a volumetric capture device, a depth-sensing camera, or a smartphone.

25. The system of claim 21, wherein the control circuitry is configured to execute the instructions to:
extract biometrical information and/or biomechanical information of the first person from the first video of the first person;
train the model of the neural network to identify the first person with the extracted biometrical information and/or the extracted biomechanical information from the first video of the first person;
capture, with an additional wearable device of an operator of the first imaging device, wherein the additional wearable device includes the first imaging device, additional biometrical information and/or additional biomechanical information of the operator; and
correlate timestamps of the extracted biometrical information and/or the extracted biomechanical information of the first person with timestamps of the additional biometrical information and/or the additional biomechanical information of the operator,
wherein the trained model of the neural network trained to identify the first person with the extracted biometrical information and/or the extracted biomechanical information includes analyzing the correlated, additional biometrical information and/or the correlated, additional biomechanical information of the operator.

26. The system of claim 25, wherein the additional wearable device is at least one of augmented reality glasses, mixed reality glasses, a light field camera, a volumetric capture device, a depth-sensing camera, a smartphone, a smart watch, or a smart ring.

27. The system of claim 21, wherein the control circuitry configured to execute the instructions to verify the identity of the first person engaged in the in-person interaction is configured to execute the instructions to:
prompt an operator of the first imaging device to verify the first person.

28. The system of claim 21, wherein the control circuitry is configured to execute the instructions to:
extract biometrical information and/or biomechanical information of the first person from the first video of the first person; and
train the model of the neural network to identify the first person with the extracted biometrical information and/or the extracted biomechanical information from the first video of the first person,
wherein the biometrical information and/or the biomechanical information includes information based on at least one of behavioral profiling, face recognition, gait, hand geometry, iris recognition, palm veins, retina recognition, a shape of ears, vocal biometrics, or voice recognition.

29. The system of claim 21, wherein the biomechanical information includes information based on at least one of arm movement analysis, eye movement analysis, finger movement analysis, gait analysis, hand movement analysis, head movement analysis, kinematics, markerless motion capture, or posture analysis.

30. The system of claim 21, wherein the control circuitry is configured to execute the instructions to:
extract biometrical information and/or biomechanical information of the first person from the first video of the first person; and
train the model of the neural network to identify the first person with the extracted biometrical information and/or the extracted biomechanical information of the first person from the first video.

31.-100. (canceled)
